(19) United States
(12) Patent Application Publication
(10) Pub. No.: US 2025/0212290 A1
(43) Pub. Date: Jun. 26, 2025

(54) USER EQUIPMENT AND METHOD FOR DRX OPERATION

(71) Applicant: SHARP KABUSHIKI KAISHA, Sakai City, Osaka (JP)

(72) Inventors: HSIN-HSI TSAI; HENG-LI CHIN, Taipei (TW)

(21) Appl. No.: 18/850,265

(22) PCT Filed: Mar. 22, 2023
(86) PCT No.: PCT/CN2023/083209

§ 371 Date: Sep. 24, 2024

Related U.S. Application Data
(60) Provisional application No. 63/269,963, filed on Mar. 25, 2022.

(51) Int. Cl. H04W 76/28; H04L 1/1812; H04W 72/231

(52) U.S. Cl. CPC H04W 76/28; H04L 1/1812; H04W 72/231

(57) ABSTRACT

A method performed by a user equipment (UE) for a Discontinuous Reception (DRX) operation is provided. The method receives, from a base station (BS), a Radio Resource Control (RRC) reconfiguration message including a DRX configuration for a serving cell. The method determines a DRX active period based on the DRX configuration. The method performs Physical Downlink Control Channel (PDCCH) monitoring during the DRX active period. The method receives a first indication from the BS. The method stops the PDCCH monitoring during the DRX active period for a specific duration in response to receiving the first indication.

### CROSS-REFERENCE TO RELATED APPLICATION(S)

The present disclosure is the National Stage Application of International Patent Application Serial No. PCT/CN2023/083209, filed on Mar. 22, 2023, which claims the benefit of and priority to U.S. Provisional Patent Application Ser. No. 63/269,963, filed on Mar. 25, 2022, the contents of all of which are hereby incorporated herein fully by reference into the present application for all purposes.

### FIELD

The present disclosure is related to wireless communication and, more specifically, to a user equipment (UE), base station (BS), and method for Discontinuous Reception (DRX) operations in the wireless communication networks.

### BACKGROUND

Various efforts have been made to improve different aspects of wireless communication for cellular wireless communication systems, such as the 5th Generation (5G) New Radio (NR), by improving data rate, latency, reliability, and mobility. The 5G NR system is designed to provide flexibility and configurability to optimize network services and types, accommodating various use cases, such as enhanced Mobile Broadband (eMBB), massive Machine-Type Communication (mMTC), and Ultra-Reliable and Low-Latency Communication (URLLC). However, as the demand for radio access continues to grow, there exists a need for further improvements in the art, such as improvements in DRX operations.

### SUMMARY

The present disclosure is related to a UE, a BS, and a method for DRX operations in the wireless communication networks.

In a first aspect of the present disclosure, a method performed by a UE for a DRX operation is provided. The method includes receiving, from a base station (BS), a first Radio Resource Control (RRC) reconfiguration message including a first DRX configuration for a first serving cell, the first DRX configuration indicating at least one non-integer value for a DRX cycle; receiving, from the BS, a first indication for adjusting a first DRX active time configured by the first DRX configuration to a second DRX active time; and performing Physical Downlink Control Channel (PDCCH) monitoring during the second DRX active time.

In a second aspect of the present disclosure, a UE for DRX operation is provided. The UE includes one or more processors and at least one memory coupled to at least one of the one or more processors, the at least one memory storing computer-executable instructions that, when executed by the at least one of the one or more processors, cause the UE to receive, from a BS, a first RRC reconfiguration message including a first DRX configuration for a first serving cell, the first DRX configuration indicating at least one non-integer value for a DRX cycle; receive, from the BS, a first indication for adjusting a first DRX active time configured by the first DRX configuration to a second DRX active time; and perform PDCCH monitoring during the second DRX active time.

In a third aspect of the present disclosure, a method performed by a UE for a DRX operation is provided. The method includes receiving, from a BS, an RRC reconfiguration message including a DRX configuration for a serving cell; determining a DRX active period based on the DRX configuration; performing PDCCH monitoring during the DRX active time; receiving a first indication from the BS; and stopping the PDCCH monitoring during the DRX active period for a specific duration in response to receiving the first indication.

In some implementations of the third aspect, the first indication is received via RRC signaling.

In some implementations of the third aspect, the first indication is received via Downlink Control Information DCI addressed to a specific Radio Network Temporary Identifier (RNTI) different from a Cell-RNTI (C-RNTI).

In some implementations of the third aspect, the specific duration is indicated by the first indication, configured via RRC signaling, or determined based on a specific timer.

In some implementations of the third aspect, the stopping of the PDCCH monitoring starts at an offset after receiving the first indication, and the offset is indicated by the first indication or configured via RRC signaling.

In some implementations of the third aspect, the method further includes stopping a DRX timer configured by the DRX configuration in response to receiving the first indication.

In some implementations of the third aspect, the DRX timer includes at least one of a DRX inactivity timer, a DRX on-duration timer, a DRX retransmission timer, a DRX Hybrid Automatic Repeat Request (HARQ) Round Trip Time (RTT) timer, and a DRX short cycle timer.

In some implementations of the third aspect, the method further includes receiving a second indication from the BS; and restarting the PDCCH monitoring during the DRX active period in response to receiving the second indication.

In some implementations of the third aspect, the first indication and the stopping of the PDCCH monitoring are specific to the serving cell.

In a fourth aspect of the present disclosure, a UE for DRX operation is provided. The UE includes at least one processor; and at least one non-transitory computer-readable medium that is coupled to the at least one processor and that stores one or more computer-executable instructions. The computer-executable instructions, when executed by the at least one processor, cause the UE to: receive, from a BS, an RRC reconfiguration message including a DRX configuration for a serving cell; determine a DRX active period based on the DRX configuration; perform PDCCH monitoring during the DRX active time; receive a first indication from the BS; and stop the PDCCH monitoring during the DRX active period for a specific duration in response to receiving the first indication.

In a fifth aspect of the present disclosure, a BS for configuring a DRX operation is provided. The BS includes at least one processor and at least one non-transitory computer-readable medium that is coupled to the at least one processor and that stores one or more computer-executable instructions. The computer-executable instructions, when executed by the at least one processor, cause the BS to: transmit, to a UE, an RRC reconfiguration message including a DRX configuration for a serving cell; and transmit a first indication to the UE. The UE determines a DRX active period based on the DRX configuration, performs PDCCH monitoring during the DRX active period, and stops the PDCCH monitoring during the DRX active period for a specific duration in response to receiving the first indication.

### BRIEF DESCRIPTION OF THE DRAWINGS

Aspects of the present disclosure are best understood from the following detailed disclosure when read with the accompanying drawings. Various features are not drawn to scale. Dimensions of various features may be arbitrarily increased or reduced for clarity of discussion.

FIG. 1 is a timing diagram illustrating a DRX operation, according to an example implementation of the present disclosure.

FIG. 2A is a diagram illustrating early data arrival, according to an example implementation of the present disclosure.

FIG. 2B is a diagram illustrating early data arrival, according to an example implementation of the present disclosure.

FIG. 3 is a flowchart illustrating a method/process performed by a UE for DRX operation, according to an example implementation of the present disclosure.

FIG. 4 is a diagram illustrating receiving a start indication, according to an example implementation of the present disclosure.

FIG. 5 is a diagram illustrating a shift of DRX timer, according to an example implementation of the present disclosure.

FIG. 6 is a diagram illustrating a specific timer/window for PDCCH monitoring, according to an example implementation of the present disclosure.

FIG. 7 is a diagram illustrating receiving a stop indication, according to an example implementation of the present disclosure.

FIG. 8 is a diagram illustrating an example of stopping a DRX timer, according to an example implementation of the present disclosure.

FIG. 9 is a diagram illustrating switching between different DRX active configurations, according to an example implementation of the present disclosure.

FIG. 10 is a block diagram illustrating a node for wireless communication, according to an example implementation of the present disclosure.

### DETAILED DESCRIPTION

Some of the abbreviations used in this disclosure include:

| Abbreviation | Full name |
|---|---|
| 3GPP | 3^{rd} Generation Partnership Project |
| 5G | 5^{th} Generation |
| ACK | Acknowledgment |
| AR | Augmented Reality |
| BS | Base Station |
| BSR | Buffer Status Report |
| BW | Bandwidth |
| BWP | Bandwidth Part |
| C-RNTI | Cell-Radio Network Temporary Identifier |
| CA | Carrier Aggregation |
| CG | Cloud Gaming |
| CORESET | Control Resource Set |
| CP | Cyclic Prefix |
| CRC | Cyclic Redundancy Check |
| DC | Dual Connectivity |
| DCI | Downlink Control Information |
| DCP | DCI with CRC scrambled by PS-RNTI |
| DL | Downlink |
| DRB | Data Radio Bearer |
| DRX | Discontinuous Reception |
| E-UTRA | Evolved Universal Terrestrial Radio Access |
| FPS | Frame Per Second |
| FR | Frequency Range |
| HARQ | Hybrid Automatic Repeat Request |
| HARQ-ACK | HARQ Acknowledgement |
| ID | Identifier |
| IE | Information Element |
| LCH | Logical Channel |
| LTE | Long Term Evolution |
| MAC | Medium Access Control |
| MAC CE | MAC Control Element |
| MCG | Master Cell Group |
| MN | Master Node |
| MR | Mixed Reality |
| Msg | Message |
| NACK | Negative Acknowledgment |
| NR | New Radio |
| NW | Network |
| OFDM | Orthogonal Frequency Division Multiplexing |
| PCell | Primary Cell |
| PDB | Packet Delay Budget |
| PDCCH | Physical Downlink Control Channel |
| PDCP | Packet Data Convergence Protocol |
| PDSCH | Physical Downlink Shared Channel |
| PHY | Physical (layer) |
| PS-RNTI | Power Saving-Radio Network Temporary Identifier |
| PSCell | Primary SCG Cell |
| PUCCH | Physical Uplink Control Channel |
| PUSCH | Physical Uplink Shared Channel |
| RA | Random Access |
| RAN | Radio Access Network |
| Rel | Release |
| RF | Radio Frequency |
| RLC | Radio Link Control |
| RNTI | Radio Network Temporary Identifier |
| RRC | Radio Resource Control |
| RS | Reference Signal |
| RTT | Round Trip Time |
| SA | System Aspects |
| SCell | Secondary Cell |
| SCG | Secondary Cell Group |
| SDAP | Service Data Adaptation Protocol |
| SFN | System Frame Number |
| SI | System Information |
| SN | Secondary Node |
| SpCell | Special Cell |
| SPS | Semi-Persistent Scheduling |
| SR | Scheduling Request |
| SRB | Signaling Radio Bearer |
| TA | Timing Advance |
| TR | Technical Report |
| TRP | Transmission/Reception Point |
| TS | Technical Specification |
| UE | User Equipment |
| UL | Uplink |
| VR | Virtual Reality |
| XR | eXtended Reality |

The following contains specific information related to implementations of the present disclosure. The drawings and their accompanying detailed disclosure are merely directed to implementations. However, the present disclosure is not limited to these implementations. Other variations and implementations of the present disclosure will be obvious to those skilled in the art.

Unless noted otherwise, like or corresponding elements among the drawings may be indicated by like or corresponding reference numerals. Moreover, the drawings and illustrations in the present disclosure are generally not to scale and are not intended to correspond to actual relative dimensions.

For consistency and ease of understanding, like features may be identified (although, in some examples, not illustrated) by the same numerals in the drawings. However, the features in different implementations may be different in other respects and shall not be narrowly confined to what is illustrated in the drawings.

References to “one implementation,” “an implementation,” “example implementation,” “various implementations,” “some implementations,” “implementations of the present application,” etc., may indicate that the implementation(s) of the present application so described may include a particular feature, structure, or characteristic, but not every possible implementation of the present application necessarily includes the particular feature, structure, or characteristic. Further, repeated use of the phrase “in one implementation,” or “in an example implementation,” “an implementation,” do not necessarily refer to the same implementation, although they may. Moreover, any use of phrases like “implementations” in connection with “the present application” are never meant to characterize that all implementations of the present application must include the particular feature, structure, or characteristic, and should instead be understood to mean “at least some implementations of the present application” includes the stated particular feature, structure, or characteristic. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series, and the equivalent.

The expression “at least one of A, B and C” or “at least one of the following: A, B and C” means “only A, or only B, or only C, or any combination of A, B and C.” The terms “system” and “network” may be used interchangeably. The term “and/or” is only an association relationship for describing associated objects and represents that three relationships may exist such that A and/or B may indicate that A exists alone, A and B exist at the same time, or B exists alone. The character “/” generally represents that the associated objects are in an “or” relationship.

For the purposes of explanation and non-limitation, specific details, such as functional entities, techniques, protocols, and standards, are set forth for providing an understanding of the disclosed technology. In other examples, detailed disclosure of well-known methods, technologies, systems, and architectures are omitted so as not to obscure the present disclosure with unnecessary details.

Persons skilled in the art will immediately recognize that any network function(s) or algorithm(s) disclosed may be implemented by hardware, software, or a combination of software and hardware. Disclosed functions may correspond to modules which may be software, hardware, firmware, or any combination thereof.

A software implementation may include computer executable instructions stored on a computer-readable medium, such as memory or other type of storage devices. One or more microprocessors or general-purpose computers with communication processing capability may be programmed with corresponding executable instructions and perform the disclosed network function(s) or algorithm(s).

The microprocessors or general-purpose computers may include Application-Specific Integrated Circuits (ASICs), programmable logic arrays, and/or one or more Digital Signal Processor (DSPs). Although some of the disclosed implementations are oriented to software installed and executing on computer hardware, alternative implementations implemented as firmware, as hardware, or as a combination of hardware and software are well within the scope of the present disclosure. The computer-readable medium includes but is not limited to Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture such as a Long-Term Evolution (LTE) system, an LTE-Advanced (LTE-A) system, an LTE-Advanced Pro system, or a 5G NR Radio Access Network (RAN) typically includes at least one base station (BS), at least one UE, and one or more optional network elements that provide connection within a network. The UE communicates with the network such as a Core Network (CN), an Evolved Packet Core (EPC) network, an Evolved Universal Terrestrial RAN (E-UTRAN), a 5G Core (5GC), or an internet via a RAN established by one or more BSs.

A UE may include, but is not limited to, a mobile station, a mobile terminal or device, or a user communication radio terminal. The UE may be a portable radio equipment that includes, but is not limited to, a mobile phone, a tablet, a wearable device, a sensor, a vehicle, or a Personal Digital Assistant (PDA) with wireless communication capability. The UE is configured to receive and transmit signals over an air interface to one or more cells in a RAN.

The BS may be configured to provide communication services according to at least a Radio Access Technology (RAT) such as Worldwide Interoperability for Microwave Access (WiMAX), Global System for Mobile communications (GSM) that is often referred to as 2G, GSM Enhanced Data rates for GSM Evolution (EDGE) RAN (GERAN), General Packet Radio Service (GPRS), Universal Mobile Telecommunication System (UMTS) that is often referred to as 3G based on basic wideband-code division multiple access (W-CDMA), high-speed packet access (HSPA), LTE, LTE-A, evolved LTE (eLTE) that is LTE connected to 5GC, NR (often referred to as 5G), and/or LTE-A Pro. However, the scope of the present disclosure is not limited to these protocols.

The BS may include, but is not limited to, a node B (NB) in the UMTS, an evolved node B (eNB) in LTE or LTE-A, a radio network controller (RNC) in UMTS, a BS controller (BSC) in the GSM/GERAN, an ng-eNB in an Evolved Universal Terrestrial Radio Access (E-UTRA) BS in connection with 5GC, a next generation Node B (gNB) in the 5G-RAN, or any other apparatus capable of controlling radio communication and managing radio resources within a cell. The BS may serve one or more UEs via a radio interface.

The BS is operable to provide radio coverage to a specific geographical area using multiple cells forming the RAN. The BS supports the operations of the cells. Each cell is operable to provide services to at least one UE within its radio coverage.

Each cell (often referred to as a serving cell) provides services to serve one or more UEs within its radio coverage such that each cell schedules the DL and optionally UL resources to at least one UE within its radio coverage for DL and optionally UL packet transmissions. The BS may communicate with one or more UEs in the radio communication system via the cells.

A cell may allocate sidelink (SL) resources for supporting Proximity Service (ProSe) or Vehicle to Everything (V2X) service. Each cell may have overlapped coverage areas with other cells.

In Multi-RAT Dual Connectivity (MR-DC) cases, the primary cell of a Master Cell Group (MCG) or a Secondary Cell Group (SCG) may be referred to as a Special Cell (SpCell). A Primary Cell (PCell) may include the SpCell of an MCG. A Primary SCG Cell (PSCell) may include the SpCell of an SCG. An MCG may include a group of serving cells associated with the Master Node (MN), including the SpCell and optionally one or more Secondary Cells (SCells). An SCG may include a group of serving cells associated with the Secondary Node (SN), including the SpCell and optionally one or more SCells.

As described above, the frame structure for NR supports flexible configurations for accommodating various next generation (e.g., 5G) communication requirements, such as Enhanced Mobile Broadband (eMBB), Massive Machine Type Communication (mMTC), and Ultra-Reliable and Low-Latency Communication (URLLC), while fulfilling high reliability, high data rate, and low latency requirements. The Orthogonal Frequency-Division Multiplexing (OFDM) technology in the 3GPP may serve as a baseline for an NR waveform. The scalable OFDM numerology, such as adaptive sub-carrier spacing, channel bandwidth, and Cyclic Prefix (CP), may also be used.

Two coding schemes are considered for NR, specifically Low-Density Parity-Check (LDPC) code and Polar Code. The coding scheme adaption may be configured based on channel conditions and/or service applications.

At least DL transmission data, a guard period, and a UL transmission data should be included in a transmission time interval (TTI) of a single NR frame. The respective portions of the DL transmission data, the guard period, and the UL transmission data should also be configurable based on, for example, the network dynamics of NR. The SL resources may also be provided in an NR frame to support ProSe services or V2X services.

Any two or more than two of the following sentences, paragraphs, (sub)-bullets, points, actions, behaviors, terms, alternatives, aspects, examples, or claims described in the present disclosure may be combined logically, reasonably, and properly to form a specific method.

Any sentence, paragraph, (sub)-bullet, point, action, behaviors, terms, alternatives, aspects, examples, or claims described in the present disclosure may be implemented independently and separately to form a specific method.

Dependency, e.g., “based on”, “more specifically”, “preferably”, “in one embodiment”, “in one alternative”, “in one example”, “in one aspect”, “in one implementation”, “in some implementations”, etc., in the present disclosure is just one possible example which would not restrict the specific method.

One aspect of the present disclosure may be used, for example, in a communication, communication equipment (e.g., a mobile telephone apparatus, ad base station apparatus, a wireless LAN apparatus, and/or a sensor device, etc.), and integrated circuit (e.g., a communication chip) and/or a program, etc.

Examples of some selected terms in the present disclosure are provided as follows.

UE: The UE may be referred to as the PHY/MAC/RLC/PDCP/SDAP entity. The PHY/MAC/RLC/PDCP/SDAP entity may also be referred to as the UE.

BS: The BS may include a network node, a TRP, a cell (e.g., SpCell, PCell, PSCell, and/or SCell), an eNB, or a gNB.

Serving Cell: the serving cell may include a PCell, a PSCell, or an SCell. The serving cell may be an activated or a deactivated serving cell.

Special Cell (SpCell): For a Dual Connectivity operation, the term Special Cell may include the PCell of the MCG or the PSCell of the SCG, depending on whether the MAC entity is associated with the MCG or the SCG. Otherwise, the term Special Cell may include the PCell. A Special Cell may support the PUCCH transmission and the contention-based Random Access, and may always be activated.

### XR Enhancements for NR

The RANI Rel-17 Study Item “Study on XR Evaluations for NR” has shown that the extended Reality (XR) and the Cloud Gaming (CG) are within the use cases and services considered important for NR in Rel-18 and beyond. In general, the XR and CG are wide terms referring to various types of augmented, virtual, and mixed environments, where human-to-machine and human-to-human communications are performed with the assistance of handheld and wearable end user devices (e.g., UEs).
Cloud Gaming (CG) may include a group of use cases, where the overwhelming majority of computations related to the gaming (single-player or multi-player) is offloaded from the UE to the edge or remote server(s).
extended Reality (XR) is a broad-scope umbrella for multiple heterogeneous use cases and services, that were studied and outlined in SA1, SA2, and SA4, including, but not limited to, the TR 22.842 and TR 26.928. These XR use cases may be roughly divided into: (i) augmented reality (AR); (ii) virtual reality (VR), and (iii) mixed reality (MR).

While the XR and CG present a set of attractive use cases for the future mobile systems, they also impose a set of challenges in NR that may need to be studied and potentially addressed.

Many of the XR and CG use cases are characterized by the quasi-periodic traffic (with possible jitter) with high data rate in the DL (e.g., video stream) combined with the frequent UL (e.g., pose/control update) and/or UL video stream. Both DL and UL traffic may also be characterized by a relatively strict packet delay budget (PDB). Hence, there is a need to study and potentially specify possible solutions to better support such challenging services, e.g., by better matching the non-integer periodicity of traffic, such as 60/90/120 frames per second to the NR signalling.

Many of the end user XR and CG devices are expected to be mobile and of a small-scale, thus having limited battery power resources. Therefore, additional power enhancements may be needed to reduce the overall UE power consumption when running the XR and CG services, and thus, extend the effective UE battery lifetime. From the Release 17 Study Item on “XR evaluations,” it is identified that the current DRX configurations may not fit well for (i) the non-integer XR traffic periodicity, (ii) variable XR data rate and (iii) quasi-periodic XR periodicity, hence enhancements would be beneficial in these areas.

The set of anticipated XR and CG services has a certain variety and the characteristics of the data streams (e.g., video) may change “on-the-fly”, while the services are running over the NR. Therefore, additional information on the running services from the higher layers may be beneficial to facilitate informed choices of radio parameters. From the Release 17 Study item on “XR evaluations”, XR application awareness by the UE and gNB may improve the user experience, improve the NR system capacity in supporting the XR services, and reduce the UE power consumption. It is expected that the SA Working Groups may lead the work on identifying necessary enhancements to improve the XR awareness, and that RAN may be made aware of these enhanced parameters and may potentially tailor the radio processing of XR traffic.

### DRX

When the UE is in an RRC_CONNECTED state, the UE/MAC entity may be configured (by the RRC layer and/or by the BS) with a DRX functionality that controls the UE/MAC entity's PDCCH monitoring activity. If the DRX is configured, for all the activated Serving Cells, the UE/MAC entity may monitor the PDCCH discontinuously, according to the configured DRX operation. The DRX operation may be characterized as follows:

on-duration: the on-duration may include a duration controlled by the drx-onDuration Timer that the UE waits for, after waking up, to receive the PDCCHs. If the UE successfully decodes a PDCCH, the UE may stay awake and may start the inactivity-timer.

DRX cycle: the DRX cycle may specify the periodic repetition of the on-duration followed by a possible period of inactivity (e.g., configured by the drx-LongCycleStartOffset, drx-ShortCycle, and/or drx-ShortCycle Timer).

DRX inactivity timer: the DRX inactivity timer may include a duration controlled by the drx-Inactivity Timer that the UE requires to decode a PDCCH, from the last successful decoding of a PDCCH. Conversely, if no PDCCH is decoded successfully while the drx-Inactivity Timer is running, the UE may return to sleep. The UE may restart the inactivity timer following a single successful decoding of a PDCCH for a first transmission only (e.g., not for retransmissions).

DRX retransmission timer: the DRX retransmission timer may include a duration until a retransmission may be expected, which is controlled by the drx-RetransmissionTimerDL, and drx-Retransmission Timer UL.

DRX HARQ RTT timer: the DRX HARQ RTT timer may include a minimum duration before a DL assignment for a HARQ retransmission (configured by drx-HARQ-RTT-TimerDI.) or the minimum duration before a UL HARQ retransmission grant (configured by drx-HARQ-RTT-Timer (II.).

DRX slot offset: the DRX slot offset may include the delay before starting the drx-onDurationTimer (e.g., configured by drx-SlotOffset).

Active Time: the Active Time may include a total duration that the UE monitors the PDCCH. This may include the “on-duration” of the DRX cycle, the time during which the UE is performing the continuous reception, while the inactivity timer has not expired, and the time during which the UE is performing the continuous reception, while waiting for a retransmission opportunity. More specifically, when the DRX is configured, the Active Time for Serving Cells may include the time while:
the drx-onDurationTimer or drx-Inactivity Timer is running; or
the drx-RetransmissionTimerDL or drx-RetransmissionTimerUL is running on any Serving Cell; or
the ra-ContentionResolutionTimer or msgB-Response Window is running; or
a Scheduling Request is sent on the PUCCH and is pending; or
a PDCCH indicating a new transmission addressed to the C-RNTI of the MAC entity has not been received after a successful reception of a Random Access Response for the Random Access Preamble not selected by the MAC entity among the contention-based Random Access Preambles.

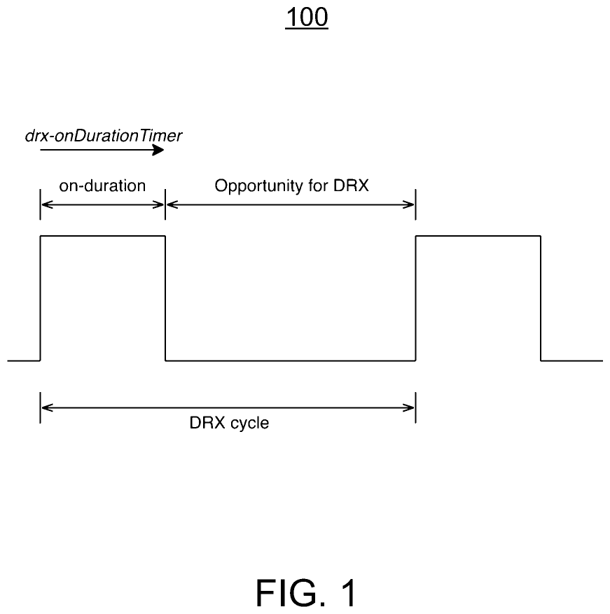

FIG. 1 is a timing diagram 100 illustrating a DRX operation according to an example implementation of the present disclosure. For each DRX cycle, the UE may start a drx-onDurationTimer at the beginning of the DRX cycle. The start timing of the drx-onDuration Timer at the beginning of the DRX cycle may be followed by an offset (e.g., drx-SlotOffset). For example, the UE may start the drx-onDuration Timer after drx-SlotOffset from the beginning of the subframe of the DRX cycle. While the drx-onDurationTimer is running, the UE is in Active Time and the UE may keep monitoring the PDCCH.

### Jitter Handling

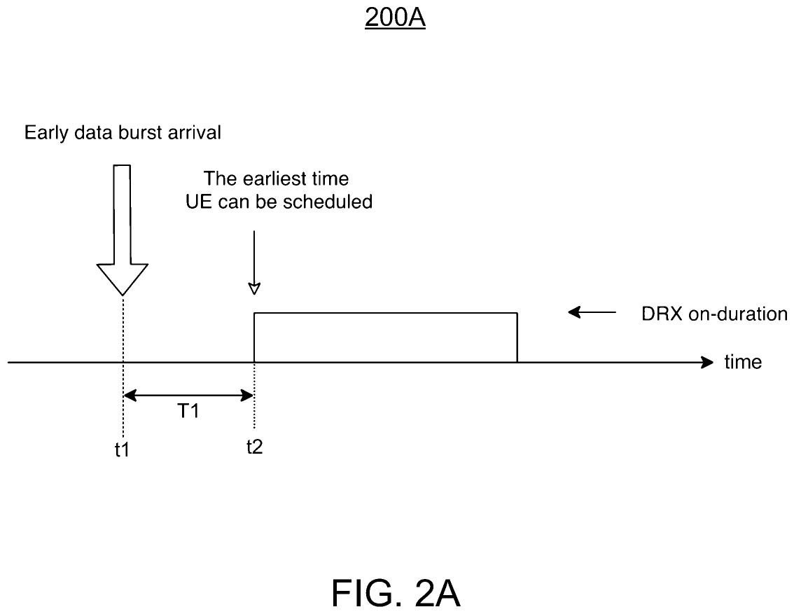

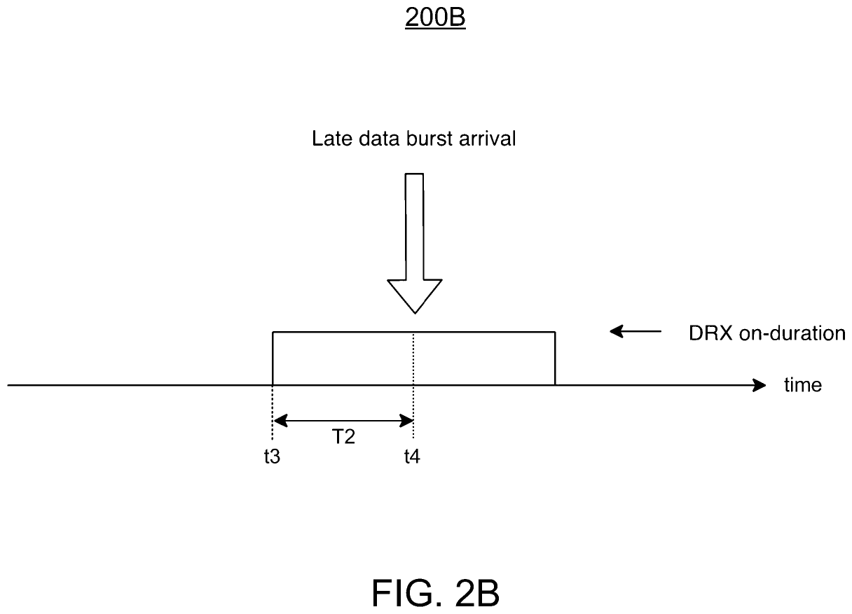

The XR DL/UL traffic arrival may have jitter, which makes the exact frame arrival timing random due to the random delay contributed from frame encoders in the Edge server, network transfer time in core network, etc. FIG. 2A is a diagram 200A illustrating early data arrival, according to an example implementation of the present disclosure. If traffic arrives too early, e.g., at time t1, the packets may need to be delayed for a period T1 until the UE wakes up from a connected mode DRX (C-DRX) off state to a C-DRX on state (e.g., within the DRX on-duration) at time t2, which may increase the latency for the packet transmission. This may potentially negatively affect the capacity given the tight PDB.

On the other hand, there may still be some problems if the data burst arrives later than the expected time of arrival (e.g., the start of the DRX on-duration). FIG. 2B is a diagram 200B illustrating early data arrival, according to an example implementation of the present disclosure. The data burst arrives at time t4, which is later than the expected time of arrival t3 (e.g., the start of the DRX on-duration). The UE may need to wait for the data burst arrival while performing unnecessary PDCCH monitoring during the period T2. The unnecessary PDCCH monitoring may increase the UE's power consumption. In order to resolve the jitter issues, as described above, several implementations are described in the present disclosure.

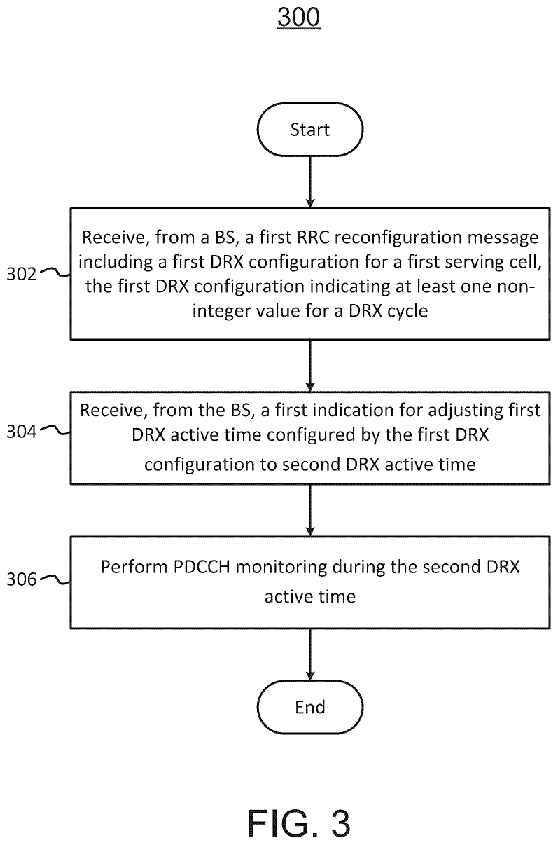

FIG. 3 is a flowchart illustrating a method/process 300 performed by a UE for DRX operation, according to an example implementation of the present disclosure. In action 302, the process 300 may start by receiving, from a BS, a first RRC reconfiguration message including a first DRX configuration for a first serving cell. The first DRX configuration may indicate at least one non-integer value for a DRX cycle. The first DRX configuration may configure a first DRX active time for the UE. The UE may monitor the PDCCH during the first DRX active time.

In the XR and CG use cases, because the packets may be received and transmitted in a periodic manner, the UE may adopt the DRX operation to take advantage of the characteristic of the periodic packet transmission. In addition, the periodic packet transmission in XR and CG use cases may be associated with the frame rate of video streaming, such as 60/90/120 frames per second, which may cause a non-integer millisecond periodicity. By configuring at least one non-integer value for the DRX cycle in the first DRX configuration, the UE may improve the power saving and also may adapt to the XR and CG use cases.

In some implementations, the at least one non-integer value for the DRX cycle may include a rational number. In some implementations, the at least one non-integer value for the DRX cycle may be represented in decimal, such as 33.33, 16.67, 11.11, 8.33, etc. In some implementations, the at least one non-integer value for the DRX cycle may be represented in fraction, such as 100/3, 50/3, 100/9, 25/3, etc. These numbers may indicate a DRX cycle length in milliseconds (ms).

In action 304, the process 300 may receive, from the BS, a first indication for adjusting the first DRX active time configured by the first DRX configuration to a second DRX active time. The DRX active time may include the time during which the UE is considered to be monitoring the PDCCH. In action 306, the process 300 may perform the PDCCH monitoring during the second DRX active time. The UE may perform the PDCCH monitoring during the first DRX active time before receiving the first indication, and may perform the PDCCH monitoring during the second DRX active time after receiving the second indication. The process 300 may then end.

As may be seen in FIG. 2A and FIG. 2B, early data arrival or late data arrival due to jitter may cause problems. In order to resolve the jitter issues that may appear in the XR traffic, the first indication may adjust the DRX active time of the UE. For example, for early data arrival, as illustrated in FIG. 2A, by adjusting the DRX active time, the UE may start the DRX active time earlier to avoid additional packet delay T1. For late data arrival, as illustrated in FIG. 2B, by adjusting the DRX active time, the UE may start the DRX active time later to avoid unnecessary PDCCH monitoring during the period T2.

Several implementations regarding the first indication for adjusting the first DRX active time to the second DRX active time are described in the present disclosure.

### Start Indication

In some implementations, the first indication in action 304 may indicate the start timing of the PDCCH monitoring. In some implementations, the first indication in action 304 may be a start indication.

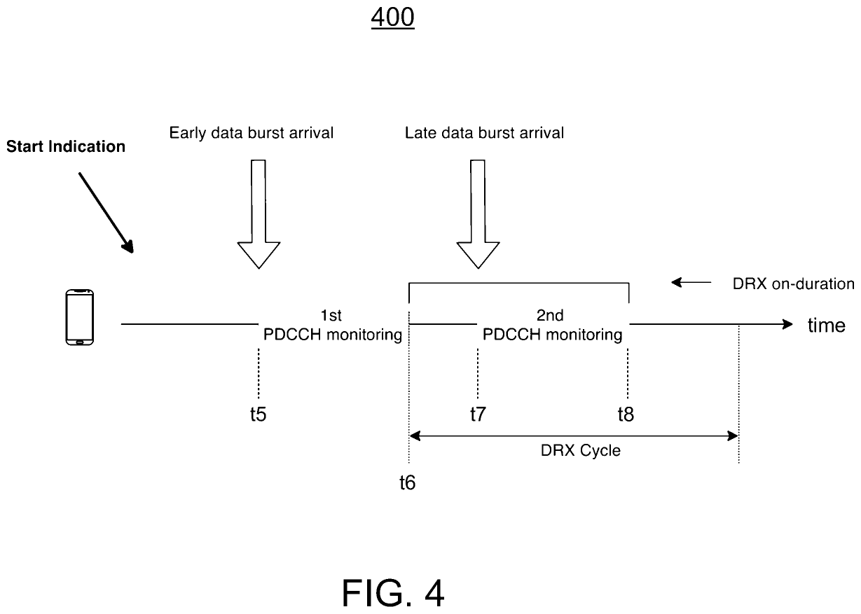

FIG. 4 is a diagram 400 illustrating receiving a start indication, according to an example implementation of the present disclosure. In some implementations, a start indication may be used to trigger an early/late start of the PDCCH monitoring. In some implementations, a start indication may be used to determine the DRX active time.

As illustrated in FIG. 4, the UE may perform the PDCCH monitoring based on the configured DRX on-duration, such as starting at time t6 and ending at time t8. The start indication may be used to change the time at which the UE starts the PDCCH monitoring. In some implementations, upon receiving the start indication, the UE may start the PDCCH monitoring at time t5 (e.g., early start of the PDCCH monitoring), hence overcoming the early data burst arrival issue. In some implementations, upon receiving the start indication, the UE may start the PDCCH monitoring at time t7 (e.g., late start of the PDCCH monitoring), hence overcoming the late data burst arrival issue. In some implementations, upon receiving the start indication, the UE may perform a 1st PDCCH monitoring from time t5 to time t6, then perform a 2nd PDCCH monitoring from time t7 to time t8, and then perform the PDCCH monitoring based on the originally configured DRX on-duration, such as during the configured DRX on-duration in the next DRX cycle(s).

In some implementations, the start indication may include information for indicating how/when the UE starts the PDCCH monitoring. In some implementations, the start indication may include information indicating how/when the UE determines the DRX active time.

In some implementations, the start indication may include information for adjusting the PDCCH monitoring's timing. The start indication may indicate whether the UE performs early start of the PDCCH monitoring (e.g., before the start of the DRX cycle and/or DRX on-duration), late start of the PDCCH monitoring (e.g., after the start of the DRX cycle and/or DRX on-duration), and/or follow the original start of the DRX cycle and/or DRX on-duration.

In some implementations, the start indication may indicate when the UE starts the PDCCH monitoring (and/or determines the DRX Active Time) before/after the start of the DRX cycle and/or DRX on-duration. The UE may start the PDCCH monitoring (and/or determines the DRX Active Time) before/after an offset from the start of the DRX cycle and/or DRX on-duration. In some implementations, the offset may be configured by RRC signaling. In some implementations, the offset may be indicated by the start indication.

In some implementations, the start indication may indicate when the UE starts the PDCCH monitoring (and/or determines the DRX Active Time) after receiving the start indication. In some implementations, the UE may start the PDCCH monitoring (and/or determine the DRX Active Time) after an offset upon receiving the start indication. In some implementations, the offset may be configured by RRC signaling. In some implementations, the offset may be indicated by the start indication. In some implementations, the UE may start the PDCCH monitoring (and/or determine the DRX Active Time) after an application delay upon receiving the start indication.

In some implementations, the first RRC reconfiguration message received in action 302 may further indicate an offset. In some implementations, the start timing of the PDCCH monitoring may occur at the offset after the reception of the first indication. In some implementations, the start timing of the PDCCH monitoring may occur at the offset after the start of the configured DRX cycle and/or the configured DRX on-duration.

In some implementations, the start indication may indicate start timing to start the PDCCH monitoring (and/or to determine the DRX Active Time). In some implementations, one or more start timings may be configured by the RRC configuration (e.g., the first RRC configuration in action 302). Then the start indication may indicate one of the start timings configured by the RRC configuration.

In some implementations, the start indication may indicate a duration/length for the PDCCH monitoring. The UE may perform the PDCCH monitoring within the duration.

In some implementations, one or more durations/lengths may be configured by the RRC configuration (e.g., the first RRC configuration in action 302). Then the start indication may indicate one of the durations/lengths configured by the RRC configuration.

The duration/length of the PDCCH monitoring may be defined by the number of time units. The time unit may include a symbol, a slot, a subframe, a system frame, a millisecond, second, a specific DRX cycle, etc.

The duration/length of the PDCCH monitoring may be continued until the UE receives the next start indication.

The duration/length may be defined by a new timer/window and/or a specific timer/window. The specific timer/window may be (re) started upon/after receiving the start indication. The specific timer/window may be (re) started before/after the start of the DRX cycle and/or the DRX on-duration. The UE may (re) start the specific timer/window before/after an offset upon/after receiving the start indication. In some implementations, the UE may (re) start the specific timer/window before/after an offset from the start of the DRX cycle and/or the DRX on-duration. The offset may be configured by RRC signaling and/or indicated by the start indication.

The UE may stop monitoring the PDCCH outside the duration/length indicated by the start indication regardless of the DRX cycle and/or the DRX on-duration. In some implementations, when the UE receives a start indication that indicates a duration/length, the UE may stop monitoring the PDCCH outside the duration/length indicated by the start indication even if the UE's DRX timer is still running (e.g., DRX inactivity timer, DRX on-duration timer, DRX retransmission timer for DL, DRX retransmission timer for UL, DRX HARQ RTT timer for DL, DRX HARQ RTT timer for UL, DRX short cycle timer, XR-specific DRX timer, etc., is still running).

In some implementations, when the UE receives a start indication, the UE may monitor the PDCCH based on an offset and a duration/length indicated by the start indication. The UE may start monitoring the PDCCH at the offset before/after the DRX cycle. Moreover, the UE may monitor the PDCCH for the duration/length indicated for the PDCCH monitoring.

In some implementations, the start indication (e.g., the first indication in action 304) may indicate end timing for the PDCCH monitoring (and/or determines the DRX Active Time).

In some implementations, the UE may stop monitoring the PDCCH after the end timing indicated by the start indication regardless of the DRX cycle and/or DRX on-duration. In some implementations, when the UE receives a start indication that indicates an end timing, the UE may stop monitoring the PDCCH outside the duration/length indicated by the start indication even if the UE's DRX timer is still running (e.g., DRX inactivity timer, DRX on-duration timer, DRX retransmission timer for DL, DRX retransmission timer for UL, DRX HARQ RTT timer for DL, DRX HARQ RTT timer for UL, DRX short cycle timer, XR-specific DRX timer, etc., is still running). In some implementations, when the UE receives a start indication, the UE may monitor the PDCCH based on an offset and an end timing indicated by the start indication. The UE may start monitoring the PDCCH at the offset before/after the DRX cycle. Moreover, the UE may monitor the PDCCH until the end timing indicated by the PDCCH monitoring.

In some implementations, the start indication may indicate the number of DRX cycles and/or a valid period (e.g., may be defined by a validity timer) during which the UE applies the function of the start indication for the PDCCH monitoring. The function may be referred to as the start timing, duration/length, shifting DRX timer, and/or end timing as indicating by the start indication. The valid period may be defined by a new timer/window.

In some implementations, The UE may stop applying the function indicated by the start indication after the number of DRX cycles and/or the valid period indicated by the start indication. For example, the first indication in action 304 may indicate a validity period of the second DRX active time. The UE may perform the PDCCH monitoring during the second DRX active time during the validity period in action 306. After the validity period expires, the UE may perform the PDCCH monitoring during the first DRX active time.

When the UE receives a start indication, the UE may monitor the PDCCH based on an offset and a valid period indicated by the start indication. The UE may start monitoring the PDCCH at the offset before/after the DRX cycle. Moreover, the UE may apply the offset for the PDCCH monitoring only during the valid period. The UE may stop applying the offset for the PDCCH monitoring outside the valid period.

In some implementations, when the UE receives the start indication, the UE may apply the function of the start indication for the PDCCH monitoring until the UE receives a terminating indication.

Upon receiving the terminating indication, the UE may stop applying the function indicated by the start indication for the PDCCH monitoring. The function may be referred to as the start timing, duration/length, shifting DRX timer, and/or end timing indicating by the start indication. When the UE receives a start indication, the UE may monitor the PDCCH based on an offset indicated by the start indication. The UE may start monitoring PDCCH at the offset before/after the DRX cycle. Subsequently, UE may stop applying the offset for the PDCCH monitoring upon reception of the terminating indication.

In some implementations, the PDCCH monitoring indicated by the start indication may be monitored while a specific timer/window is running. The specific timer/window may be (re) started upon/after receiving the start indication. The specific timer/window may be (re) started before/after the start of the DRX cycle and/or DRX on-duration. In some implementations, the UE may (re) start the specific timer/window before/after an offset upon/after receiving the start indication. In some implementations, the UE may (re) start the specific timer/window before/after an offset from the start of the DRX cycle and/or DRX on-duration. The offset may be configured by RRC signaling and/or indicated by the start indication.

In some implementations, the PDCCH monitoring indicated by the start indication may be monitored on a specific search space/CORESET.

In some implementations, the PDCCH monitoring indicated by the start indication may be addressed to a specific RNTI. The specific RNTI/search space/CORESET may be a specific RNTI/search space/CORESET, as described in the present disclosure. The specific RNTI/search space/CORESET may be mapped to one or more XR services. The specific RNTI/search space/CORESET may be configured via the specific DRX configuration and/or a configuration for the XR. The specific RNTI/search space/CORESET may be configured to the UE via RRC signaling. The specific RNTI/search space/CORESET may be associated with the DCI to schedule a DL resource (e.g., PDSCH) and/or a UL resource (e.g., PUSCH) including the XR services. The specific RNTI may be associated with the DCI to preempt other UL/DL traffics.

In some implementations, the start indication may be indicated for at least one (or all) MAC entity/DRX group/DRX configuration/Cell Group (MCG/SCG)/cell/serving cell/BWP/set of cells that is configured with the specific DRX configuration.

If the start indication is indicated for at least one (or all) MAC entity/DRX group/DRX configuration/Cell Group (MCG/SCG)/cell/serving cell/BWP/set of cells/XR services that is configured with the specific DRX configuration, the UE may apply the function of the start indication (e.g., for the PDCCH monitoring) to the indicated MAC entity/DRX group/DRX configuration/Cell Group (MCG/SCG)/cell/serving cell/BWP/set of cells/XR services that is configured with the specific DRX configuration. On the other hand, the UE may not apply the function of the start indication (e.g., for the PDCCH monitoring) to the other MAC entity/DRX group/DRX configuration/Cell Group (MCG/SCG)/cell/serving cell/BWP/set of cells/XR services.

In some implementation, the start indication may further include the following information:
The start indication may indicate information of at least one (or all) MAC entity/DRX group/DRX configuration/Cell Group (MCG/SCG)/cell/serving cell/BWP/set of cells/XR services.
The start indication may indicate a specific DRX cycle.
The start indication may indicate the value for deriving the specific DRX cycle.
The start indication may be a UL grant and/or a DL assignment that schedules XR traffics.
The start indication may be DCI received on a PDCCH/search space/CORESET configured for XR traffics.
The start indication may be a PDCCH/DCI addressed to a specific RNTI (e.g., XR-RNTI).
The start indication may be a PDCCH/DCI monitored/received on a specific search space/CORESET (e.g., for XR).
The start indication may be a PDCCH/DCI with a specific DCI format (e.g., for XR).
The start indication may be a PDSCH including XR traffics. The PDSCH may correspond to a specific SPS configured for XR services.

In some implementations, the start indication may be indicated by DCI, a system information, RRC configuration, and/or MAC CE (e.g., an XR MAC CE).

In some implementations, the start indication may be DCI formats 0_0, 0_1, 0_2, 0_3, 1_0, 1_1, 1_2, 1_3, 2_0, 2_1, 2_2, 2_3, 2_4, 2_5, 2_6, 2_7, 2_8, 3_0, 3_1, 4_0, 4_1, 4_2. The start indication may be used for the XR, PDCCH monitoring (and/or determine the DRX Active Time), and/or power saving. In some implementations, the start indication may be a DCI format 2_6. A DCI format 2_6 may be used for notifying the power saving information outside DRX Active Time for one or more UEs. The DCI format 2_6 may be DCI with CRC scrambled by PS-RNTI (DCP).

In some implementations, the start indication may be a DCI format for scheduling of PUSCH (e.g., DCI format 0_0, DCI format 0_1, DCI format 0_2) and/or PDSCH (e.g., DCI format 1_0, DCI format 1_1, DCI format 1_2). In some implementations, the start indication may be an indication used for search space set group switching and skipping of the PDCCH monitoring (e.g., PDCCH skipping).

In some implementations, the start indication may be indicated before/after the start of DRX cycle and/or DRX on-duration. In some implementations, an offset may be used to indicate the monitoring occasion between the start indication and the start/end of the DRX cycle (or the DRX on-duration). The DRX cycle may be a short DRX cycle, a long DRX cycle, a non-integer DRX cycle, and/or an XR DRX cycle. In some implementations, the non-integer DRX cycle may be indicated by one or more decimals (e.g., 33.33 ms, 16.67 ms, 11.11 ms, 8.33 ms, etc.). In some implementations, the non-integer DRX cycle may be indicated by one or more fractions (e.g., 100/3 ms, 50/3 ms, 25/3 ms, etc.).

In some implementations, the start indication may be monitored while a specific timer/window is running. Referring to FIG. 3, the first indication in action 304 may be received in a time window configured by the first RRC reconfiguration message in action 302. The specific timer/window may be (re) started before/after the start of the DRX cycle and/or DRX on-duration. In some implementations, the UE may (re) start the specific timer/window before/after an offset from the start of the DRX cycle and/or DRX on-duration. The offset may be configured by RRC signaling and/or indicated by the start indication.

In some implementations, the start indication may be monitored on a specific search space/CORESET. In some implementations, the start indication may be addressed to a specific RNTI. Referring to FIG. 3, the first indication in action 304 may be received via a DCI format scrambled by a RNTI specific to XR services.

The specific RNTI/search space/CORESET may be a specific RNTI/search space/CORESET, as described in the present disclosure. The specific RNTI/search space/CORESET may be mapped to one or more XR services. The specific RNTI/search space/CORESET may be configured via the specific DRX configuration and/or a configuration for the XR. The specific RNTI/search space/CORESET may be configured to the UE via RRC signaling. The specific RNTI/search space/CORESET may be associated with DCI to schedule a DL resource (e.g., PDSCH) and/or a UL resource (e.g., PUSCH) including the XR services. The specific RNTI may be associated with the DCI to preempt other UL/DL traffics.

In some implementations, the start indication may be monitored when the UE is in the DRX Active Time. In some implementations, the start indication may be monitored when the UE is not in the DRX Active Time.

In some implementations, the start indication may be monitored during a DRX on-duration. In some implementations, the start indication may not be monitored during a DRX on-duration.

In some implementations, the start indication and/or the information for the start indication may be configured by a specific DRX configuration. The specific DRX configuration may be an XR DRX configuration. The specific DRX configuration that indicates one or more non-integer values for DRX cycle may be configured via an IE DRX-ConfigNonIntegerCycles. The specific DRX configuration may be configured/indicated by system information, RRC configuration, MAC CE, and/or DCI.

### Shift DRX Timer-Specific Indication

As illustrated in FIG. 3, the first indication adjusts the first DRX active time to the second DRX active time. In some implementations, the UE may shift the first DRX active time to obtain the second DRX active time, according to the first indication, which may be referred to as a specific indication in the present disclosure.

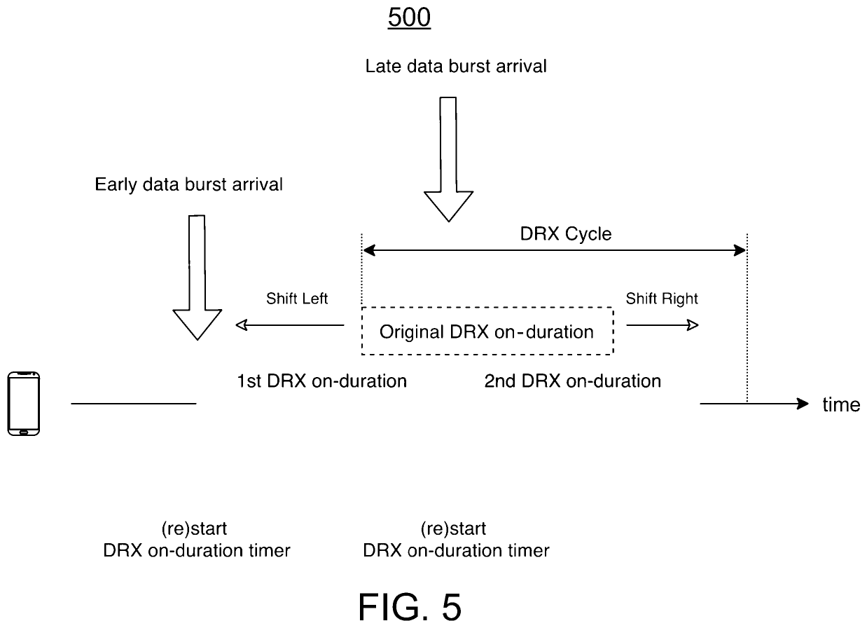

FIG. 5 is a diagram 500 illustrating a shift of DRX timer, according to an example implementation of the present disclosure. A DRX timer (e.g., DRX on-duration timer) may be early/late (re) started based on some criteria. The DRX timer may be a DRX inactivity timer, DRX on-duration timer, DRX retransmission timer for DL, DRX retransmission timer for UL, DRX HARQ RTT timer for DL, DRX HARQ RTT timer for UL, DRX short cycle timer, XR-specific DRX timer.

As illustrated in FIG. 5, the original DRX on-duration may correspond to the first DRX active time in action 304. In some implementations, the original DRX on-duration may be shifted left to the 1st DRX on-duration in FIG. 5, which may correspond to the second DRX active time in action 304. The DRX on-duration may be early shifted to overcome the issue of early data burst arrival. The UE may (re) start the DRX on-duration timer at the start of the 1st DRX on-duration. In some implementations, the original DRX on-duration may be shifted right to the 2nd DRX on-duration in FIG. 5, which may correspond to the second DRX active time in action 304. The DRX on-duration may be late shifted to overcome the issue of late data burst arrival. The UE may (re) start the DRX on-duration timer at the start of the 2nd DRX on-duration.

In some implementations, the UE may determine whether to early/late (re) start the DRX timer based on a specific indication, e.g., DCI, a system information, RRC configuration/IE, and/or MAC CE (e.g., an XR MAC CE).

In some implementations, the specific indication may be indicated for at least one (or all) MAC entity/DRX group/DRX configuration/Cell Group (MCG/SCG)/cell/serving cell/BWP/set of cells which is configured with the specific DRX configuration.

In some implementations, if the specific indication is indicated for at least one (or all) MAC entity/DRX group/DRX configuration/Cell Group (MCG/SCG)/cell/serving cell/BWP/set of cells that is configured with the specific DRX configuration, the UE may apply the function of the specific indication (e.g., to (re) start the DRX timer) to the indicated MAC entity/DRX group/DRX configuration/Cell Group (MCG/SCG)/cell/serving cell/BWP/set of cells that is configured with the specific DRX configuration. On the other hand, the UE may not apply the function of the specific indication (e.g., to (re) start the DRX timer) to the other MAC entity/DRX group/DRX configuration/Cell Group (MCG/SCG)/cell/serving cell/BWP/set of cells.

In some implementations, if the UE is indicated to early (re) start the DRX timer, the DRX timer may be (re) started before (shifted by) an offset from a specific time. The specific time may be the start/end of the DRX cycle and/or DRX on-duration. The offset may be configured by RRC signaling and/or indicated by specific indication.

In some implementations, if the UE is indicated to late (re) start the DRX timer, the DRX timer may be (re) started after (shifted by) an offset from a specific time. The specific time may be the start/end of the DRX cycle and/or DRX on-duration. The specific time may be the time when receiving the specific indication or at an offset after receiving the specific indication. The offset may be configured by RRC signaling and/or indicated by specific indication.

In some implementations, if the UE is indicated to (re) start the DRX timer by default, the UE may (re) start the DRX timer based on drx-SlotOffset and/or drx-StartOffset and/or drx-LongCycleStartOffset.

For example, if the UE is indicated to (re) start the DRX timer by default and if the Short DRX cycle is used for a DRX group, and [(SFN×10)+subframe number] modulo (drx-ShortCycle)=(drx-StartOffset) modulo (drx-ShortCycle), the UE may start DRX timer after drx-SlotOffset from the beginning of the subframe.

For example, if the UE is indicated to (re) start the DRX timer by default and if the Long DRX cycle is used for a DRX group, and [(SFN×10)+subframe number] modulo (drx-LongCycle)=drx-StartOffset, the UE may start DRX timer after drx-SlotOffset from the beginning of the subframe.

In some implementations, if the UE does not receive the specific indication and/or is not indicated to early/late (re) start the DRX timer, the UE may (re) start the DRX timer based on at least one of drx-SlotOffset, drx-StartOffset, and drx-LongCycleStartOffset.

For example, if the UE does not receive the specific indication and/or is not indicated to early/late (re) start the DRX timer and if the Short DRX cycle is used for a DRX group, and [(SFN×10)+subframe number] modulo (drx-ShortCycle)=(drx-StartOffset) modulo (drx-ShortCycle), the UE may start DRX timer after drx-SlotOffset from the beginning of the subframe.

For example, if the UE does not receive the specific indication and/or is not indicated to early/late (re) start the DRX timer and if the Long DRX cycle is used for a DRX group, and [(SFN×10)+subframe number] modulo (drx-LongCycle)=drx-StartOffset, the UE may start DRX timer after drx-SlotOffset from the beginning of the subframe.

For example, if the UE does not receive the specific indication, the DRX timer/specific timer/new timer/window may be (re) started after (shifted by) an offset from a specific time (as defined above). Moreover, if the UE receives the specific indication, the DRX timer may be (re) started by following the legacy behavior.

In some implementations, the UE may determine whether to early/late (re) start based on the DCI.

In some implementations, the specific indication may be the start indication, as described in the present disclosure. The specific indication may be used for the XR, PDCCH monitoring (and/or to determine the DRX Active Time), and/or power saving. The specific indication may be a DCI format 2_6. A DCI format 2_6 may be used for notifying the power saving information outside DRX Active Time for one or more UEs. The DCI format 2_6 may be a DCP. The specific indication may be a DCI format for scheduling of PUSCH (e.g., DCI format 0_0, DCI format 0_1, DCI format 0_2) and/or PDSCH (e.g., DCI format 1_0, DCI format 1_1, DCI format 1_2). The specific indication may be an indication used for search space set group switching and skipping of the PDCCH monitoring (e.g., PDCCH skipping).

In some implementations, the specific indication may be indicated before/after the start of DRX cycle and/or DRX on-duration. In some implementations, an offset may be used to indicate the monitoring occasion between the specific indication and the start/end of the DRX cycle (or the DRX on-duration). The DRX cycle may be a short DRX cycle, a long DRX cycle, a non-integer DRX cycle, and/or an XR DRX cycle. In some implementations, the non-integer DRX cycle may be indicated by one or more decimals (e.g., 33.33 ms, 16.67 ms, 11.11 ms, 8.33 ms, etc.). In some implementations, the non-integer DRX cycle may be indicated by one or more fractions (e.g., 100/3 ms, 50/3 ms, 25/3 ms, etc.)

In some implementations, the specific indication may be monitored while a specific timer/window is running. Referring to FIG. 3, the first indication in action 304 (e.g., the specific indication, as described herein) may be received in a time window configured by the first RRC reconfiguration message in action 302. The specific timer/window may be (re) started before/after the start of the DRX cycle and/or DRX on-duration. In some implementations, the UE may (re) start the specific timer/window before/after an offset from the start of the DRX cycle and/or DRX on-duration. The offset may be configured by RRC signaling and/or indicated by the start indication.

In some implementations, the specific indication may be monitored on a specific search space/CORESET. In some implementations, the specific indication may be addressed to a specific RNTI. Referring to FIG. 3, the first indication in action 304 (e.g., the specific indication, as described herein) may be received via a DCI format scrambled by a RNTI specific to XR services. The specific RNTI/search space/CORESET may be a specific RNTI/search space/CORESET, as described in the present disclosure. The specific RNTI/search space/CORESET may be mapped to one or more XR services. The specific RNTI/search space/CORESET may be configured via the specific DRX configuration and/or a configuration for the XR. The specific RNTI/search space/CORESET may be configured to the UE via RRC signaling. The specific RNTI/search space/CORESET may be associated with the DCI to schedule a DL resource (e.g., PDSCH) and/or a UL resource (e.g., PUSCH) including the XR services. The specific RNTI may be associated with the DCI to preempt other UL/DL traffics.

In some implementations, the specific indication may be monitored when the UE is in the DRX Active Time. In some implementations, the specific indication may be monitored when the UE is not in the DRX Active Time.

In some implementations, the specific indication and/or the information for the specific indication may be configured by a specific DRX configuration. The specific DRX configuration may be an XR DRX configuration. The specific DRX configuration that indicates one or more non-integer values for DRX cycle may be configured via an IE DRX-ConfigNonIntegerCycles. The specific DRX configuration may be configured/indicated by a system information, RRC configuration, MAC CE, and/or the DCI.

In some implementation, the specific indication may further include the following information:
The specific indication may indicate information of at least one (or all) MAC entity/DRX group/DRX configuration/Cell Group (MCG/SCG)/cell/serving cell/BWP/set of cells.
The specific indication may indicate a specific DRX cycle.
The specific indication may indicate the value for deriving the specific DRX cycle.
The specific indication may be a UL grant and/or a DL assignment that schedules XR traffics.
The specific indication may be DCI received on a PDCCH/search space/CORESET configured for XR traffics.
The specific indication may be a PDCCH/DCI addressed to a specific RNTI (e.g., XR-RNTI).
The specific indication may be a PDCCH/DCI monitored/received on a specific
search space/CORESET (e.g., for XR).
The specific indication may be a PDCCH/DCI with a specific DCI format (e.g., for XR).
The specific indication may be a PDSCH including XR traffics. The PDSCH may correspond to a specific SPS configured for XR services.

### New Timer/Window for PDCCH Monitoring

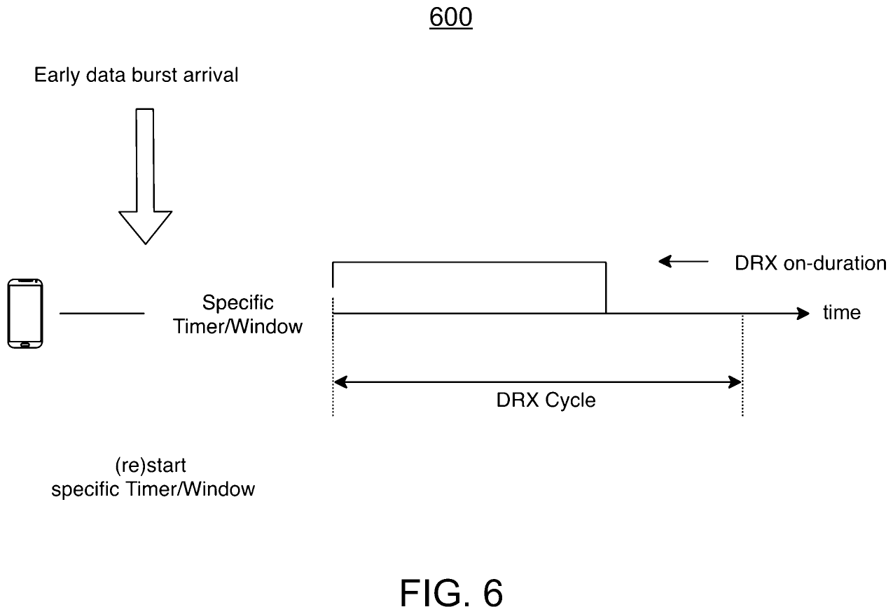

In some implementations, a specific timer/window may be introduced for the PDCCH monitoring (and/or determined as DRX Active Time). FIG. 6 is a diagram 600 illustrating a specific timer/window for PDCCH monitoring, according to an example implementation of the present disclosure. In some implementations, when the specific timer/window is running, the UE may monitor the PDCCH (and/or determine the DRX Active Time). In one example, when the specific timer/window is running, the UE may monitor the PDCCH addressed to a specific RNTI and/or on a specific search space/CORESET. As illustrated in FIG. 6, by introducing the specific timer/window, the UE may adjust the active time during which the PDCCH is monitored and may thus resolve the jitter issue.

The specific RNTI/search space/CORESET may be a specific RNTI/search space/CORESET, as described in the present disclosure. The specific RNTI/search space/CORESET may be mapped to one or more XR services. The specific RNTI/search space/CORESET may be configured via the specific DRX configuration and/or a configuration for the XR. The specific RNTI/search space/CORESET may be configured to the UE via RRC signaling. The specific RNTI/search space/CORESET may be associated with the DCI to schedule a DL resource (e.g., PDSCH) and/or a UL resource (e.g., PUSCH) including the XR services. The specific RNTI may be associated with the DCI to preempt other UL/DL traffics.

In some implementations, the specific timer/window may be (re) started based on one or more of the following conditions.

In some implementations, the specific timer/window may be (re) started after receiving the start/stop indication, as described in the present disclosure and/or the specific indication, as described in the present disclosure. The specific timer/window may be (re) started after an offset when receiving the start/stop indication and/or the specific indication. The offset may be configured by RRC signaling and/or indicated by the start indication and/or the specific indication. In one example, the specific timer/window may be (re) started after an application delay when receiving the start/stop indication and/or the specific indication.

In some implementations, the specific timer/window may be (re) started before/after the start of the DRX cycle and/or DRX on-duration. The specific timer/window may be (re) started before/after an offset from the start of the DRX cycle and/or DRX on-duration. The offset may be configured by RRC signaling and/or indicated by the start indication and/or the specific indication.

In some implementations, the specific timer/window may be (re) started based on at least one parameter. The parameter may be a DRX parameter. The DRX parameter may be the drx-SlotOffset, drx-LongCycleStartOffset, drx-ShortCycle, drx-StartOffset, ps-Wakeup. The parameter may be used to indicate whether the specific timer/window is enabled/disabled. The specific timer/window may be (re) started when the parameter indicates a first value. The specific timer/window may not be (re) started when the parameter indicates a second value. The specific timer/window may be stopped when the parameter indicates a third value.

In some implementations, the specific timer/window may be (re) started based on at least one timer. The timer may be a DRX timer. The DRX timer may be the DRX inactivity timer, DRX on-duration timer, DRX retransmission timer for DL, DRX retransmission timer for UL, DRX HARQ RTT timer for DL, DRX HARQ RTT timer for UL, DRX short cycle timer, XR-specific DRX timer, etc. The specific timer/window may be (re) started when the timer expires and/or is not running. The specific timer/window may be (re) started when the timer is running.

In some implementations, the specific timer/window may be stopped based on one or more of the following conditions.

In some implementations, the specific timer/window may be stopped after receiving an indication (e.g., a stop indication). The indication may be DCI, system information, RRC configuration, and/or MAC CE (e.g., an XR MAC CE). The indication may be a DRX command MAC CE, a long DRX command MAC CE, and/or an XR DRX command MAC CE. The indication may be used for search space set group switching and/or skipping of the PDCCH monitoring (e.g., PDCCH skipping indication). The indication may be referred to as the start/stop/skip indication and/or the terminating indication, as described in the present disclosure.

In some implementations, the specific timer/window may be stopped based on at least one timer. The timer may be a DRX timer. The DRX timer may be the DRX inactivity timer, DRX on-duration timer, DRX retransmission timer for DL, DRX retransmission timer for UL, DRX HARQ RTT timer for DL, DRX HARQ RTT timer for UL, DRX short cycle timer, XR-specific DRX timer, new timer/window etc. The specific timer/window may be stopped when the timer is (re) started. The specific timer/window may be stopped when the timer expires and/or is not running. The timer may be used to define the valid period (e.g., may be defined by a validity timer). The specific timer/window may be stopped when the corresponding DRX configuration is (re) configured. The specific timer/window may be stopped when the serving cell in which the specific timer/window has been configured is (de) activated/expired/stopped. The specific timer/window may be stopped when the BWP in which the specific timer/window has been configured is no longer an active BWP, e.g., due to BWP switching.

In some implementations, when the specific timer/window expires, the UE may (re) start a DRX timer. The DRX timer may be the DRX inactivity timer, DRX on-duration timer, DRX retransmission timer for DL, DRX retransmission timer for UL, DRX HARQ RTT timer for DL, DRX HARQ RTT timer for UL, DRX short cycle timer, XR-specific DRX timer, etc.

In some implementations, the specific timer/window may be configured/performed/started/stopped for at least one (or all) MAC entity/DRX group/DRX configuration/Cell Group (MCG/SCG)/cell/serving cell/BWP/set of cells which is configured with the specific DRX configuration.

If the specific timer/window is configured/performed/started/stopped for at least one (or all) MAC entity/DRX group/DRX configuration/Cell Group (MCG/SCG)/cell/serving cell/BWP/set of cells that is configured with the specific DRX configuration, the UE may apply the function of the specific indication (e.g., to perform/start/stop the specific timer/window) for the corresponding MAC entity/DRX group/DRX configuration/Cell Group (MCG/SCG)/cell/serving cell/BWP/set of cells that is configured with the specific DRX configuration. On the other hand, the UE may not apply the function of the specific indication (e.g., to perform/start/stop the specific timer/window) to the other MAC entity/DRX group/DRX configuration/Cell Group (MCG/SCG)/cell/serving cell/BWP/set of cells.

In some implementations, the specific timer/window may be configured by a specific DRX configuration. The specific DRX configuration may be an XR DRX configuration. The specific DRX configuration that indicates one or more non-integer values for DRX cycle may be configured via an IE DRX-ConfigNonIntegerCycles. The specific DRX configuration may be configured/indicated by system information, RRC configuration, MAC CE, and/or DCI. The duration/length of the specific timer/window may be defined by the number of time units. The time unit may be symbol, slot, subframe, system frame, ms, s, a specific DRX cycle, etc.

### Stop/Skip Indication

In some implementations, the first indication in action 304 may indicate an end timing of the PDCCH monitoring. In some implementations, the first indication in action 304 may be a stop/skip indication. The stop/skip indication may be used to trigger stop/skip of the PDCCH monitoring. In some implementations, the stop indication may include information for indicating how/when the UE stops/skips the PDCCH monitoring (and/or determines the non-DRX Active Time).

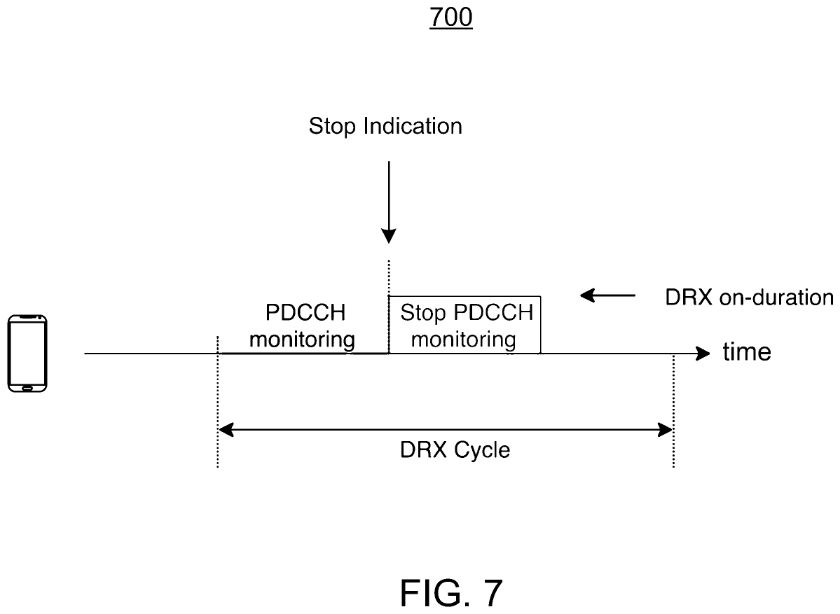

FIG. 7 is a diagram 700 illustrating receiving a stop indication, according to an example implementation of the present disclosure. The UE may perform the PDCCH monitoring in the configured DRX on-duration and then stops the PDCCH monitoring upon receiving the stop indication, effectively adjusting the DRX active time.

In some implementations, when the UE is indicated to stop/skip the PDCCH monitoring, the UE may stop one or more of the DRX timers, e.g., a specific DRX inactivity timer, DRX on-RTT timer for DL, DRX HARQ RTT timer for UL, DRX short cycle timer, XR-specific DRX timer.

In some implementations, when the UE is indicated to stop/skip the PDCCH monitoring, the UE may stop one or more of the specific timers and/or new timer/window, as described in the present disclosure.

In some implementations, when the UE is indicated to stop/skip the PDCCH monitoring, the UE may stop/skip the PDCCH monitoring regardless of whether the UE is in Active Time and/or whether any DRX timer is running.

In some implementations, the stop indication may indicate when the UE stops/skips the PDCCH monitoring (and/or determines the non-DRX Active Time) before/after the start of the DRX cycle and/or DRX on-duration. In some implementations, the UE may stop/skip the PDCCH monitoring (and/or determines the DRX Active Time) before/after an offset from the start of the DRX cycle and/or DRX on-duration. The offset may be configured by RRC signaling and/or indicated by the stop/skip indication.

In some implementations, the stop/skip indication may indicate when the UE stops/skips the PDCCH monitoring (and/or determines the non-DRX Active Time) after receiving the stop/skip indication. In some implementations, the UE may stop/skip the PDCCH monitoring (and/or determines the non-DRX Active Time) after an offset when receiving the stop/skip indication. The offset may be configured by RRC signaling and/or indicated by the stop/skip indication. In some implementations, the UE may stop/skip the PDCCH monitoring (and/or determines the DRX Active Time) after an application delay when receiving the stop/skip indication.

In some implementations, the first RRC reconfiguration message received in action 302 may further indicate an offset. In some implementations, the end timing of the PDCCH monitoring may occur at the offset after reception of the first indication. In some implementations, the end timing of the PDCCH monitoring may occur at the offset after the start of the configured DRX cycle and/or configured DRX on-duration.

In some implementations, the stop/skip indication may indicate start timing to stop/skip the PDCCH monitoring (and/or determines the DRX Active Time). In some implementations, one or more start timings may be configured by RRC configuration (e.g., the first RRC configuration in action 302). Then the stop/skip indication may indicate one of the start timings configured by the RRC configuration.

In some implementations, the stop/skip indication may indicate a duration/length for stopping/skipping the PDCCH monitoring. The UE may stop/skip the PDCCH monitoring within the duration.

In some implementations, one or more durations/lengths may be configured by RRC configuration (e.g., the first RRC configuration in action 302). Then the stop/skip indication may indicate one of the durations/lengths configured by the RRC configuration.

The duration/length of the stopping/skipping the PDCCH monitoring may be defined by the number of time units. The time unit may be symbol, slot, subframe, system frame, ms, s, a specific DRX cycle, etc.

The duration/length of the stopping/skipping the PDCCH monitoring may be continued until the UE receives the next stop/skip indication.

The duration/length may be defined by a new timer/window (e.g., as depicted in FIG. 6) and/or a specific timer/window. The specific timer/window may be (re) started upon/after receiving the stop/skip indication. The specific timer/window may be (re) started before/after the start of the DRX cycle and/or DRX on-duration. The UE may (re) start the specific timer/window before/after an offset upon/after receiving the stop/skip indication. In some implementations, the UE may (re) start the specific timer/window before/after an offset from the start of the DRX cycle and/or DRX on-duration. The offset may be configured by RRC signaling and/or indicated by the stop/skip indication.

The UE may monitor PDCCH outside the duration/length. The UE may (re) start the DRX timer and/or the specific timer and/or the new timer/window at the end of the duration/length.

In some implementations, the stop/skip indication may indicate end timing for stopping/skipping the PDCCH monitoring (and/or determines the DRX Active Time). The UE may monitor PDCCH after the end timing indicated by the stop/skip indication. The UE may (re) start the DRX timer and/or the new timer/window after the end timing indicated by the stop/skip indication.

In some implementations, when the UE receives the stop/skip indication, the UE may apply the function of the stop/skip indication for the PDCCH monitoring until the UE receives a terminating indication.

After receiving the terminating indication, the UE may start to monitor PDCCH. After receiving the terminating indication, the UE may (re) start the DRX timer and/or the new timer/window.

In some implementations, the stop/skip indication may indicate the number of DRX cycles for stopping/skipping the PDCCH monitoring. After the number of DRX cycles indicated by the stop/skip indication, the UE may start to monitor PDCCH. After the number of DRX cycles indicated by the stop/skip indication, the UE may (re) start the DRX timer and/or the new timer/window.

In some implementations, the stop/skip indication may be indicated for at least one (or all) MAC entity/DRX group/DRX configuration/Cell Group (MCG/SCG)/cell/serving cell/BWP/set of cells which is configured with the specific DRX configuration.

In some implementations, if the stop/skip indication is indicated for at least one (or all) MAC entity/DRX group/DRX configuration/Cell Group (MCG/SCG)/cell/serving cell/BWP/set of cells that is configured with the specific DRX configuration, the UE may apply the function of the stop/skip indication (e.g., for stop/skip the PDCCH monitoring) to the indicated MAC entity/DRX group/DRX configuration/Cell Group (MCG/SCG)/cell/serving cell/BWP/set of cells that is configured with the specific DRX configuration. On the other hand, the UE may not apply the function of the stop/skip indication (e.g., for stopping/skipping the PDCCH monitoring) to the other MAC entity/DRX group/DRX configuration/Cell Group (MCG/SCG)/cell/serving cell/BWP/set of cells.

In some implementation, the stop/skip indication may further include the following information:
The stop/skip indication may indicate information of at least one (or all) MAC entity/DRX group/DRX configuration/Cell Group (MCG/SCG)/cell/serving cell/BWP/set of cells.
The stop/skip indication may indicate a specific DRX cycle.
The stop/skip indication may indicate the value for deriving the specific DRX cycle.
The stop/skip indication may be a UL grant and/or a DL assignment that schedules XR traffics.
The stop/skip indication may be DCI received on a PDCCH/search space/CORESET configured for XR traffics.
The stop/skip indication may be a PDCCH/DCI addressed to a specific RNTI (e.g., XR-RNTI).
The stop/skip indication may be a PDCCH/DCI monitored/received on a specific search space/CORESET (e.g., for XR).
The stop/skip indication may be a PDCCH/DCI with a specific DCI format (e.g., for XR).
The stop/skip indication may be a PDSCH including XR traffics. The PDSCH may correspond to a specific SPS configured for XR services.

In some implementations, the stop/skip indication may be indicated by DCI, a system information, RRC configuration, and/or MAC CE (e.g., an XR MAC CE).

In some implementations, the stop/skip indication may be DCI formats 0_0, 0_1, 0_2, 0_3, 1_0, 1_1, 1_2, 1_3, 2_0, 2_1, 2_2, 2_3, 2_4, 2_5, 2_6, 2_7, 2_8, 3_0, 3_1, 4_0, 4_1, 4_2. The stop/skip indication may be used for the XR, PDCCH monitoring (and/or determines the DRX Active Time), and/or power saving. In some implementations, the stop/skip indication may be a DCI format 2_6. A DCI format 2_6 may be used for notifying the power saving information outside DRX Active Time for one or more UEs. The DCI format 2_6 may be a DCP.

In some implementations, the stop/skip indication may be a DCI format for scheduling of PUSCH (e.g., DCI format 0_0, DCI format 0_1, DCI format 0_2) and/or PDSCH (e.g., DCI format 1_0, DCI format 1_1, DCI format 1_2). In some implementations, the stop/skip indication may be an indication used for search space set group switching and skipping of the PDCCH monitoring (e.g., PDCCH skipping).

In some implementations, the stop/skip indication may be indicated before/after the start of DRX cycle and/or DRX on-duration. In some implementations, an offset may be used to indicate the monitoring occasion between the stop/skip indication and the start/end of the DRX cycle (or the DRX on-duration). The DRX cycle may be a short DRX cycle, a long DRX cycle, a non-integer DRX cycle, and/or an XR DRX cycle. In some implementations, the non-integer DRX cycle may be indicated by one or more decimals (e.g., 33.33 ms, 16.67 ms, 11.11 ms, 8.33 ms, etc.). In some implementations, the non-integer DRX cycle may be indicated by one or more fractions (e.g., 100/3 ms, 50/3 ms, 25/3 ms, etc.).

In some implementations, the stop/skip indication may be monitored while a specific timer/window is running. Referring to FIG. 3, the first indication in action 304 may be received in a time window configured by the first RRC reconfiguration message in action 302. The specific timer/window may be (re) started before/after the start of the DRX cycle and/or DRX on-duration. In some implementations, the UE may (re) start the specific timer/window before/after an offset from the start of the DRX cycle and/or DRX on-duration. The offset may be configured by RRC signaling and/or indicated by the start indication.

In some implementations, the stop/skip indication may be monitored on a specific search space/CORESET. In some implementations, the stop/skip indication may be addressed to a specific RNTI. Referring to FIG. 3, the first indication in action 304 may be received via a DCI format scrambled by a RNTI specific to XR services.

The specific RNTI/search space/CORESET may be a specific RNTI/search space/CORESET, as described in the present disclosure. The specific RNTI/search space/CORESET may be mapped to one or more XR services. The specific RNTI/search space/CORESET may be configured via the specific DRX configuration and/or a configuration for the XR. The specific RNTI/search space/CORESET may be configured to the UE via RRC signaling. The specific RNTI/search space/CORESET may be associated with the DCI to schedule a DL resource (e.g., PDSCH) and/or a UL resource (e.g., PUSCH) including the XR services. The specific RNTI may be associated with the DCI to preempt other UL/DL traffics.

In some implementations, the stop/skip indication may be monitored when the UE is in the DRX Active Time. In some implementations, the stop/skip indication may be monitored when the UE is not in the DRX Active Time.

In some implementations, the stop/skip indication may be monitored when the UE is in the DRX Active Time and/or when the UE is not in the DRX Active Time.

In some implementations, the stop/skip indication and/or the information for the stop/skip indication may be configured by a specific DRX configuration. The specific DRX configuration may be an XR DRX configuration. The specific DRX configuration that indicates one or more non-integer values for DRX cycle may be configured via an IE DRX-ConfigNonIntegerCycles. The specific DRX configuration may be configured/indicated by system information, RRC configuration, MAC CE, and/or DCI.

### Stop DRX Timer

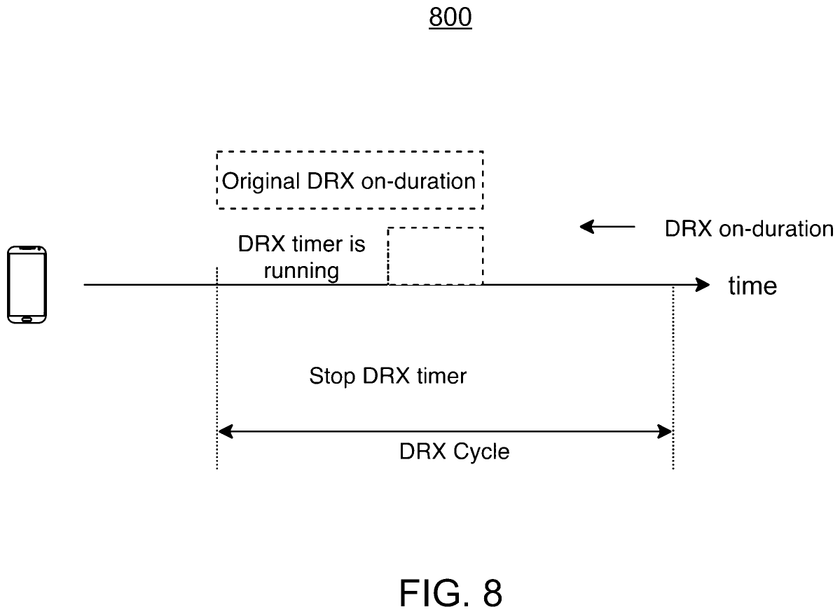

In some implementations, one or more DRX timer may be stopped based on some criteria. The DRX timer may be the DRX inactivity timer, DRX on-duration timer, DRX retransmission timer for DL, DRX retransmission timer for UL, DRX HARQ RTT timer for DL, DRX HARQ RTT timer for UL, DRX short cycle timer, XR-specific DRX timer. FIG. 8 is a diagram 800 illustrating an example of stopping a DRX timer, according to an example implementation of the present disclosure.

In some implementations, the UE may determine whether to stop the DRX timer based on a specific indication, e.g., DCI, system information, RRC configuration/IE, and/or MAC CE (e.g., an XR MAC CE).

In some implementations, the specific indication may be indicated for at least one (or all) MAC entity/DRX group/DRX configuration/Cell Group (MCG/SCG)/cell/serving cell/BWP/set of cells which is configured with the specific DRX configuration.

In some implementations, if the specific indication is indicated for at least one (or all) MAC entity/DRX group/DRX configuration/Cell Group (MCG/SCG)/cell/serving cell/BWP/set of cells/XR services that is configured with the specific DRX configuration, the UE may apply the function of the specific indication (e.g., to stop the DRX timer) to the indicated MAC entity/DRX group/DRX configuration/Cell Group (MCG/SCG)/cell/serving cell/BWP/set of cells/XR services that is configured with the specific DRX configuration. On the other hand, the UE may not apply the function of the specific indication (e.g., to stop the DRX timer) to the other MAC entity/DRX group/DRX configuration/Cell Group (MCG/SCG)/cell/serving cell/BWP/set of cells/XR services.

In some implementations, if the UE is indicated to stop the DRX timer, the DRX timer may be stopped after an offset from a specific time. The specific time may be the start/end of the DRX cycle and/or DRX on-duration. The specific time may be the time when receiving the specific indication. The offset may be configured by RRC signaling and/or indicated by specific indication.

In some implementations, if the UE does not receive the specific indication and/or is not indicated to stop the DRX timer, the UE may not stop the DRX timer. The UE may (re) start the DRX timer based on at least one of drx-SlotOffset, drx-StartOffset, and drx-LongCycleStartOffset.

In some implementations, the DRX timer may be stopped based on one or more of the following conditions.

In some implementations, the DRX timer may be stopped after receiving the stop/skip indication, as described in the present disclosure and/or the specific indication, as described in the present disclosure. For example, the DRX timer may be stopped after an offset when receiving the stop/skip indication and/or the specific indication. The offset may be configured by RRC signaling and/or indicated by the stop/skip indication and/or the specific indication. For example, the DRX timer may be stopped after an application delay when receiving the stop/skip indication and/or the specific indication.

In some implementations, the DRX timer may be stopped based on at least one timer. For example, the timer may be a DRX timer. The DRX timer may be the DRX inactivity timer, DRX on-duration timer, DRX retransmission timer for DL, DRX retransmission timer for UL, DRX HARQ RTT timer for DL, DRX HARQ RTT timer for UL, DRX short cycle timer, XR-specific DRX timer, etc. The timer may be the specific timer/window, as described in the present disclosure. The DRX timer may be stopped when the specific timer/window timer is (re) started. The DRX timer may be stopped when the specific timer/window timer expires and/or is not running.

In some implementations, the DRX timer may be stopped after the duration/length indicated by the start indication.

In some implementations, the DRX timer may be stopped after the end timing indicated by the start indication.

In some implementations, the specific indication may be a MAC CE (e.g., a DRX command MAC CE, a long DRX command MAC CE, and/or an XR DRX command MAC CE).

In some implementations, the specific indication may be DCI formats 0_0, 0_1, 0_2, 0_3, 1_0, 1_1, 1_2, 1_3, 2_0, 2_1, 2_2, 2_3, 2_4, 2_5, 2_6, 2_7, 2_8, 3_0, 3_1, 4_0, 4_1, 4_2. The specific indication may be used for the XR, PDCCH monitoring (and/or determines the DRX Active Time), and/or power saving. The specific indication may be a DCI format 2_6. A DCI format 2_6 may be used for notifying the power saving information outside DRX Active Time for one or more UEs. The DCI format 2_6 may be a DCP. The specific indication may be a DCI format for scheduling of PUSCH (e.g., DCI format 0_0, DCI format 0_1, DCI format 0_2) and/or PDSCH (e.g., DCI format 1_0, DCI format 1_1, DCI format 1_2). The specific indication may be an indication used for search space set group switching and skipping of the PDCCH monitoring (e.g., PDCCH skipping).

In some implementations, the specific indication may be indicated before/after the start of DRX cycle and/or DRX on-duration. In some implementations, an offset may be used to indicate the monitoring occasion between the specific indication and the start/end of the DRX cycle and/or the DRX on-duration. The DRX cycle may be a short DRX cycle, a long DRX cycle, a non-integer DRX cycle, and/or an XR DRX cycle. In some implementations, the non-integer DRX cycle may be indicated by one or more decimals (e.g., 33.33 ms, 16.67 ms, 11.11 ms, 8.33 ms, etc.). In some implementations, the non-integer DRX cycle may be indicated by one or more fractions (e.g., 100/3 ms, 50/3 ms, 25/3 ms, etc.)

In some implementations, the specific indication may be monitored while a specific timer/window is running. The specific timer/window may be (re) started before/after the start of the DRX cycle and/or DRX on-duration. In some implementations, the UE may (re) start the specific timer/window before/after an offset from the start of the DRX cycle and/or DRX on-duration. The offset may be configured by RRC signaling and/or indicated by the specific indication.

In some implementations, the specific indication may be monitored on a specific search space/CORESET. In some implementations, the specific indication may be addressed to a specific RNTI.

The specific RNTI/search space/CORESET may be a specific RNTI/search space/CORESET, as described in the present disclosure. The specific RNTI/search space/CORESET may be mapped to one or more XR services. The specific RNTI/search space/CORESET may be configured via the specific DRX configuration and/or a configuration for the XR. The specific RNTI/search space/CORESET may be configured to the UE via RRC signaling. The specific RNTI/search space/CORESET may be associated with the DCI to schedule a DL resource (e.g., PDSCH) and/or a UL resource (e.g., PUSCH) including the XR services. The specific RNTI may be associated with the DCI to preempt other UL/DL traffics.

In some implementations, the specific indication may be monitored when the UE is in the DRX Active Time. In some implementations, the specific indication may be monitored when the UE is not in the DRX Active Time.

In some implementations, the specific indication and/or the information for the specific indication may be configured by a specific DRX configuration. The specific DRX configuration may be an XR DRX configuration. The specific DRX configuration that indicates one or more non-integer values for DRX cycle may be configured via an IE DRX-ConfigNonIntegerCycles. The specific DRX configuration may be configured/indicated by system information, RRC configuration, MAC CE, and/or DCI.

In some implementations, the specific indication may further include one or more of the following information:
The specific indication may indicate information of at least one (or all) MAC entity/DRX group/DRX configuration/Cell Group (MCG/SCG)/cell/serving cell/BWP/set of cells.
The specific indication may indicate a specific DRX cycle.
The specific indication may indicate the value for deriving the specific DRX cycle.
The specific indication may be a UL grant and/or a DL assignment that schedules XR traffics.
The specific indication may be DCI received on a PDCCH/search space/CORESET configured for XR traffics.
The specific indication may be a PDCCH/DCI addressed to a specific RNTI (e.g., XR-RNTI).
The specific indication may be a PDCCH/DCI monitored/received on a specific search space/CORESET (e.g., for XR).
The specific indication may be a PDCCH/DCI with a specific DCI format (e.g., for XR).
The specific indication may be a PDSCH including XR traffics. The PDSCH may correspond to a specific SPS configured for XR services.

### DRX On-Duration Timer, DRX Start Offset, DRX Slot Offset

In some implementations, the UE may determine whether to (re) start a DRX timer (e.g., DRX on-duration timer) (for at least one or all MAC entity/DRX group/DRX configuration/Cell Group (MCG/SCG)/cell/serving cell/BWP/set of cells) based on the specific DRX cycle.

In some implementations, the DRX timer (e.g., DRX on-duration timer) may be (re) started after (shifted by) a time offset from a specific time. In some implementations, the DRX timer (e.g., DRX on-duration timer) may be (re) started after (shifted by) [a time offset+a drx-SlotOffset] from a specific time.

In some implementations, the DRX timer (e.g., DRX on-duration timer) may be (re) started before (shifted by) a time offset from a specific time. In some implementations, the DRX timer (e.g., DRX on-duration timer) may be (re) started before (shifted by) [a time offset+a drx-SlotOffset] from a specific time.

In some implementations, the specific DRX cycle may be (re) started after (shifted by) a start offset from a specific time. In some implementations, the specific DRX cycle may be (re) started after (shifted by) [a start offset+drx-StartOffset] from a specific time.

In some implementations, the specific DRX cycle may be (re) started before (shifted by) a start offset from a specific time. In some implementations, the specific DRX cycle may be (re) started before (shifted by) [a start offset+drx-StartOffset] from a specific time.

In some implementations, the UE may determine whether to (re) start a DRX timer (e.g., DRX on-duration timer) (for at least one or all MAC entity/DRX group/DRX configuration/Cell Group (MCG/SCG)/cell/serving cell/BWP/set of cells) based on the specific DRX cycle, the time offset, and/or the start offset.

In some implementations, the UE may determine whether to (re) start a DRX timer (e.g., DRX on-duration timer) (for at least one or all) MAC entity/DRX group/DRX configuration/Cell Group (MCG/SCG)/cell/serving cell/BWP/set of cells) based on the specific DRX cycle, the time offset, drx-SlotOffset, the start offset, and/or drx-StartOffset.

The DRX timer may be a DRX inactivity timer, DRX on-duration timer, DRX retransmission timer for DL, DRX retransmission timer for UL, DRX HARQ RTT timer for DL, DRX HARQ RTT timer for UL, DRX short cycle timer, XR-specific DRX timer, etc.

In some implementations, if the specific DRX cycle is used (for at least one or all MAC entity/DRX group/DRX configuration/Cell Group (MCG/SCG)/cell/serving cell/BWP/set of cells), and [(SFN×10)+subframe number] modulo (the specific DRX cycle)=(a start offset) modulo (the specific DRX cycle), the UE may (re) start a DRX timer (e.g., DRX on-duration timer) (for at least one or all MAC entity/DRX group/DRX configuration/Cell Group (MCG/SCG)/cell/serving cell/BWP/set of cells), e.g., before/after (shifted by) a time offset from a specific time.

In some implementations, if the specific DRX cycle is used (for at least one or all MAC entity/DRX group/DRX configuration/Cell Group (MCG/SCG)/cell/serving cell/BWP/set of cells), and [(SFN×10)+subframe number] modulo (the specific DRX cycle)=(a start offset+drx-StartOffset) modulo (the specific DRX cycle), the UE may (re) start a DRX timer (e.g., DRX on-duration timer) (for at least one or all MAC entity/DRX group/DRX configuration/Cell Group (MCG/SCG)/cell/serving cell/BWP/set of cells), e.g., before/after (shifted by) a time offset+a drx-SlotOffset from a specific time.

In some implementations, if the specific DRX cycle is used (for at least one or all MAC entity/DRX group/DRX configuration/Cell Group (MCG/SCG)/cell/serving cell/BWP/set of cells), and [(SFN×10)+subframe number] modulo (the specific DRX cycle)=a start offset, the UE may (re) start a DRX timer (e.g., DRX on-duration timer) (for at least one or all MAC entity/DRX group/DRX configuration/Cell Group (MCG/SCG)/cell/serving cell/BWP/set of cells), e.g., before/after (shifted by) a time offset from a specific time.

In some implementations, if the specific DRX cycle is used (for at least one or all MAC entity/DRX group/DRX configuration/Cell Group (MCG/SCG)/cell/serving cell/BWP/set of cells), and [(SFN×10)+subframe number] modulo (the specific DRX cycle)=(a start offset+drx-StartOffset), the UE may (re) start a DRX timer (e.g., DRX on-duration timer) (for at least one or all MAC entity/DRX group/DRX configuration/Cell Group (MCG/SCG)/cell/serving cell/BWP/set of cells), e.g., before/after (shifted by) a time offset+a drx-SlotOffset from a specific time.

In some implementations, if the specific DRX cycle is used (for at least one or all MAC entity/DRX group/DRX configuration/Cell Group (MCG/SCG)/cell/serving cell/BWP/set of cells), the UE may (re) start a DRX timer (e.g., DRX on-duration timer) (for at least one or all MAC entity/DRX group/DRX configuration/Cell Group (MCG/SCG)/cell/serving cell/BWP/set of cells) before/after (shifted by) a start offset from the beginning/start (e.g., the first slot/symbol) of the specific DRX cycle.

In some implementations, if the specific DRX cycle is used (for at least one or all MAC entity/DRX group/DRX configuration/Cell Group (MCG/SCG)/cell/serving cell/BWP/set of cells), the UE may (re) start a DRX timer (e.g., DRX on-duration timer) (for at least one or all MAC entity/DRX group/DRX configuration/Cell Group (MCG/SCG)/cell/serving cell/BWP/set of cells) before/after (shifted by) a start offset+drx-StartOffset from the beginning/start (e.g., the first slot/symbol) of the specific DRX cycle.

The specific DRX cycle may be a short DRX cycle, a long DRX cycle, a non-integer DRX cycle, and/or an XR DRX cycle.

The time offset may be in a unit of slot, symbol, subframe, system frame, ms, and/or second, DRX cycle. The time offset may be a DRX offset (e.g., drx-SlotOffset) used for the delay before starting the drx-onDurationTimer). The value of the time offset may be zero, an integer, a non-integer, a positive number, and/or a negative number. If the value of the time offset is a negative number, the UE may (re) start the DRX timer before the specific time. The time offset may be the start of the specific DRX timer relative to the start/end of the specific time.

The start offset may be in a unit of slot, symbol, subframe, system frame, and/or ms, and/or seconds, DRX cycle. The start offset (e.g., drx-StartOffset) may define the subframe/slot/symbol where a specific DRX cycle starts. The value of the start offset may be zero, an integer, a non-integer, a positive number, and/or a negative number. If the value of the start offset is a negative number, the UE may (re) start the specific DRX cycle before the specific time. The start offset may be the start of the specific DRX cycle relative to the start/end of the specific time. The configuration of the start offset may be included in a specific DRX configuration (e.g., for XR) configured by BS. The specific DRX cycle may be, e.g., a short DRX cycle, a long DRX cycle, a non-integer DRX cycle, and/or an XR DRX cycle.

The specific time may be in a unit of slot, symbol, subframe, system frame, ms, seconds, and/or DRX cycle. The specific time may be the beginning/start (e.g., the first slot/symbol) of the specific DRX cycle. The specific time may be the end (e.g., the last slot/symbol) of the specific DRX cycle. The specific time may be the start of a DRX timer (e.g., a DRX inactivity timer, DRX on-RTT timer for DL, DRX HARQ RTT timer for UL, DRX short cycle timer, XR-specific DRX timer, etc.).

The configuration of the time offset and/or the start offset may be configured by the BS, e.g., included in a specific DRX configuration.

In some implementations, the configuration of the time offset and/or the start offset may be configured per MAC entity (e.g., included in MAC-CellGroupConfig).

In some implementations, the configuration of the time offset and/or the start offset may be configured per DRX group (e.g., included in secondaryDRX-GroupConfig and/or DRX-ConfigSecondaryGroup and/or a DRX group for XR). The DRX group may be specifically configured for XR. The NW may configure the DRX group to be specifically for XR via a specific configuration/IE.

In some implementations, the configuration of the time offset and/or the start offset may be configured per DRX configuration (e.g., included in DRX-Config and/or DRX-Config2 and/or an XR DRX configuration).

In some implementations, the configuration of the time offset and/or the start offset may be configured per Cell Group (MCG/SCG) (e.g., included in CellGroupConfig). For example, the specific DRX configuration is configured for a specific Cell Group (MCG/SCG).

In some implementations, the configuration of the time offset and/or the start offset may be configured per cell/serving cell (e.g., included in SpCellConfig or SCellConfig). The cell/serving cell may be specifically configured for XR. The NW may configure the cell/serving cell to be specifically for XR via a specific configuration/IE.

In some implementations, the configuration of the time offset and/or the start offset may be configured per BWP (e.g., included in a BWP configuration). The BWP may be specifically configured for XR. The NW may configure the BWP to be specifically for XR via a specific configuration/IE.

In some implementations, the configuration of the time offset and/or the start offset may be configured per set/group of cells. The UE may be configured with one or more set/group of cells. The set/group of cells may include one or more cells. The set/group of cells may include SpCell and/or SCell(s). The UE may be indicated that each cell is related to which set/group of cells. The set/group of cells may correspond to a specific FR, e.g., FR1 and/or FR2. The set/group of cells may correspond to dormancy SCell group(s). The set of cells may be specifically configured for XR. The NW may configure the set/group of cells to be specifically for XR via a specific configuration/IE.

In some implementations, the UE may apply the time offset and/or the start offset for at least one (or all) MAC entity/DRX group/DRX configuration/Cell Group (MCG/SCG)/cell/serving cell/BWP/set of cells that is configured with the time offset and/or the start offset.

In some implementations, the UE may apply the time offset and/or the start offset for at least one (or all) MAC entity/DRX group/DRX configuration/Cell Group (MCG/SCG)/cell/serving cell/BWP/set of cells that is not configured with the specific DRX configuration.

### Adjustment/Update of Time Offset/Start Offset

In some implementations, the UE may adjust/update the value of the time offset/start offset based on a rate (e.g., drift rate). The rate may be indicated by DCI, MAC CE, and/or RRC configuration.

The rate may indicate the value for the UE to adjust/update the value of the time offset/start offset. The value X for the UE to adjust/update the value of the time offset/start offset may be in unit of slot, symbol, subframe, system frame, millisecond, and/or second, DRX cycle. The rate may indicate a value Y (e.g., via a time unit) for how long that the UE may adjust/update the value of the time offset/start offset. The value Y for how long may correspond to periodicity of XR traffic/fps (e.g., 33.33 ms, 16.67 ms, 11.11 ms, 8.33 ms).

For example, if the rate indicates X milliseconds per Y DRX cycles. The UE may adjust/update the time offset/start offset value every Y DRX cycles by X milliseconds. In some implementations, The UE may adjust/update the value of the time offset/start offset based on a value of a counter which is associated with the number of adjust/update that has been performed.

### Switching the Time Offset/Start Offset

In some implementations, the UE may switch/change the value/configuration of the time offset and/or the start offset (e.g., for at least one or all MAC entity/DRX group/DRX configuration/Cell Group (MCG/SCG)/cell/serving cell/BWP/set of cells) based on some criteria, such as an indication, a configuration, an event, a timer, and/or a counter. The UE switching DRX cycles may imply that the UE replaces a first DRX cycle with a second DRX cycle.

In some implementations, the UE may switch from a first time offset and/or start offset to a second time offset and/or start offset based on based on some criteria, such as an indication, a configuration, an event, a timer, and/or a counter.

In some implementations, after the UE switches to a second time offset and/or start offset, the UE may switch back to a first time offset and/or start offset based on based on some criteria, such as an indication, a configuration, an event, a timer, and/or a counter.

In some implementations, the UE may switch/change the value/configuration of the time offset and/or the start offset (for at least one or all MAC entity/DRX group/DRX configuration/Cell Group (MCG/SCG)/cell/serving cell/BWP/set of cells) based on an indication and/or a configuration received from a BS.

For example, when the UE receives an indication and/or a configuration from a BS, the UE may switch a first time offset and/or start offset to a second time offset and/or start offset (for at least one or all MAC entity/DRX group/DRX configuration/Cell Group (MCG/SCG)/cell/serving cell/BWP/set of cells). The UE may determine whether to switch the time offset and/or start offset (for at least one or all MAC entity/DRX group/DRX configuration/Cell Group (MCG/SCG)/cell/serving cell/BWP/set of cells) based on an indication and/or a configuration. The UE may determine to switch the first time offset and/or start offset (for at least one or all MAC entity/DRX group/DRX configuration/Cell Group (MCG/SCG)/cell/serving cell/BWP/set of cells) to which second time offset and/or start offset based on the indication and/or based on a configuration.

The indication may be DCI, MAC CE, and/or RRC configuration.

The indication may indicate the value/configuration of time offset and/or start offset. The indication may indicate information of at least one (or all) MAC entity/DRX group/DRX configuration/Cell Group (MCG/SCG)/cell/serving cell/BWP/set of cells. The indication may indicate the specific DRX cycle. The indication may indicate the value for deriving the specific DRX cycle. The indication may be a UL grant and/or a DL assignment that schedules XR traffics. The indication may be DCI received on a PDCCH/search space/CORESET configured for XR traffics. The indication may be a PDCCH/DCI addressed to a specific RNTI (e.g., XR-RNTI). The indication may be a PDCCH/DCI monitored/received on a specific search space/CORESET (e.g., for XR). The indication may be a PDCCH/DCI with a specific DCI format (e.g., for XR). The indication may be a PDSCH including XR traffics. In some implementations, the PUSCH may correspond to a specific SPS configured for XR services.

The configuration may be DCI, MAC CE, and/or RRC configuration.

The configuration may indicate the value/configuration of time offset and/or start offset. The configuration may indicate information of at least one (or all) MAC entity/DRX group/DRX configuration/Cell Group (MCG/SCG)/cell/serving cell/BWP/set of cells. The indication may indicate the specific DRX cycle. The indication may indicate the value for deriving the specific DRX cycle.

In some implementations, the UE may switch time offset and/or start offset based on an event.

In some implementations, if the UE transmits specific information, to BS, the UE may switch time offset and/or start offset (for at least one or all MAC entity/DRX group/DRX configuration/Cell Group (MCG/SCG)/cell/serving cell/BWP/set of cells).

The specific information may indicate that information for XR traffic pattern/XR application/frame per second/periodicity for DRX/pose control information. The specific information may indicate a HARQ feedback (e.g., HARQ ACK/NACK), e.g., for a DCI, a PDSCH transmission, and/or the indication for switching DRX cycle. The specific information may indicate that the UE prefers the non-integer DRX cycle. The specific information may be a PUSCH including an XR traffic. In some implementations, the PUSCH may correspond to a configured grant that is configured specifically for XR services.

In some implementations, the UE may switch time offset and/or start offset based on a timer and/or a duration (configured by BS).

For example, when a timer expires, the UE may switch time offset and/or start offset (for at least one or all MAC entity/DRX group/DRX configuration/Cell Group (MCG/SCG)/cell/serving cell/BWP/set of cells).

The timer may be a DRX timer, a specific DRX inactivity timer, DRX on-duration timer, DRX retransmission timer for DL, DRX retransmission timer for UL, DRX HARQ RTT timer for DL, DRX HARQ RTT timer for UL, DRX short cycle timer, XR-specific DRX timer, etc. The timer may be (re) started when the UE has switched the time offset and/or start offset to a first time offset and/or start offset.

The timer may be (re) started when the UE performs a (DL/UL) transmission. The timer may be (re) started when the UE receives an indication from BS (e.g., a DCI and/or a DRX command MAC CE, and/or a RRC configuration). The timer may be stopped when the UE has switched the time offset to a first time offset or a second time offset. The timer may be stopped when the UE has switched the start offset to a first start offset or a second start offset. The timer may be stopped when the UE receives an indication from BS (e.g., a DRX command MAC CE). The UE may monitor PDCCH (based on the specific RNTI, search space, and/or CORESET for XR) while the timer is running. The UE may determine Active Time while the timer is running.

In some implementations, the UE may switch time offset and/or start offset based on a counter.

For example, when a counter reaches to a maximum value, the UE may switch time offset and/or start offset (for at least one or all MAC entity/DRX group/DRX configuration/Cell Group (MCG/SCG)/cell/serving cell/BWP/set of cells).

The counter may count the number of DRX cycles. The value of the counter may be increased by 1 when a DRX cycle starts and/or ends. The counter may be reset when the UE has switched the time offset to a first time offset or a second time offset. The counter may be reset when the UE has switched the start offset to a first start offset or a second start offset. The counter may be reset when the UE performs a (DL/UL) transmission. The counter may be reset when the UE receives an indication from BS (e.g., DCI, a DRX command MAC CE, and/or an RRC configuration).

In some implementations, the UE may switch time offset and/or start offset after an offset from the time that the criterion aforementioned (e.g., based on an indication, a configuration, an event, a timer, and/or a counter) is fulfilled.

The offset may be configured from the BS. The offset may be a DRX start offset, a DRX slot offset, and/or a DRX offset. The offset may be a processing time, a switch delay, and/or an application delay for the UE.

In some implementations, if the UE is an XR-specific UE (e.g., the UE has XR capability), the UE may apply the time offset/start offset. Otherwise, the UE may apply the legacy drx-SlotOffset/drx-StartOffset.

In some implementations, if the UE transmits specific information to the BS, the UE may apply the time offset/start offset. Otherwise, the UE may apply the legacy drx-SlotOffset/drx-StartOffset.

The specific information may be transmitted via an assistance information/(JEAssistanceInformation IE (e.g., the assistance information for XR, for non-integer DRX cycle, and/or for DRX preference).

The specific information may be transmitted via a UE capability information/UECapabilityInformation IE (e.g., the UE capability information for XR, for non-integer DRX cycle, and/or for DRX preference).

The specific information may indicate information for XR traffic pattern/XR application/frame per second/periodicity for DRX/pose control information. The specific information may indicate that the UE prefers the non-integer DRX cycle. The specific information may be transmitted via an RRC message, MAC CE (e.g., a SR, a BSR, and/or an XR MAC CE), and/or a PHY signaling (e.g., on PUCCH).

In some implementations, if the UE is performing a procedure for XR, the UE may apply the time offset/start offset. Otherwise, the UE may apply the legacy drx-SlotOffset/drx-StartOffset.

The UE may enter/initiate/perform a procedure for XR when data arrives at a specific LCH/SRB/DRB for XR services and/or when the UE has pending data from the specific LCH/SRB/DRB for XR services. The specific LCH/SRB/DRB configuration for XR services may be configured by the NW for conveying XR data.

The UE may enter/initiate/perform a procedure for XR when the UE triggers/initiates a BSR/SR/RA from a specific LCH/SRB/DRB for XR services.

The UE may enter/initiate/perform a procedure for XR when the UE receives a scheduling information that schedules a UL/DL resource for transmitting UL/DL XR traffics. The UE may enter/initiate/perform a procedure for XR when the UE (successfully/unsuccessfully) receives on a DL resource (e.g., PDSCH) and/or transmits on a UL resource (e.g., PUSCH) including XR traffics. The UE may enter/initiate/perform a procedure for XR when the UE receives a specific indication from the BS. The specific indication may indicate to the UE to enter/initiate/perform a procedure for XR. The indication may be transmitted via an RRC message, a MAC CE (e.g., an XR MAC CE), and/or PHY signaling (e.g., on PDCCH).

In some implementations, if the UE receive a specific indication from the BS, the UE may apply the time offset/start offset. Otherwise, the UE may apply the legacy drx-SlotOffset/drx-StartOffset.

The specific indication may indicate to the UE to enter/initiate/perform a procedure for XR. The indication may be transmitted via an RRC message, a MAC CE (e.g., an XR MAC CE), and/or a PHY signaling (e.g., on PDCCH).

In some implementations, if the UE is configured with a specific configuration/IE, the UE may apply the time offset/start offset. Otherwise, the UE may apply the legacy drx-SlotOffset/drx-StartOffset.

The specific configuration/IE may indicate scheduling information for XR traffic. The specific configuration/IE may trigger a procedure for XR. The specific configuration/IE may be a specific configured grant/SPS configuration for XR services. The specific configured grant/SPS configuration for XR services may be configured by the NW for transmitting UL/DL XR data. The specific configuration/IE may be a specific LCH/SRB/DRB for XR services. The specific LCH/SRB/DRB configuration for XR services may be configured by the NW for conveying XR data.

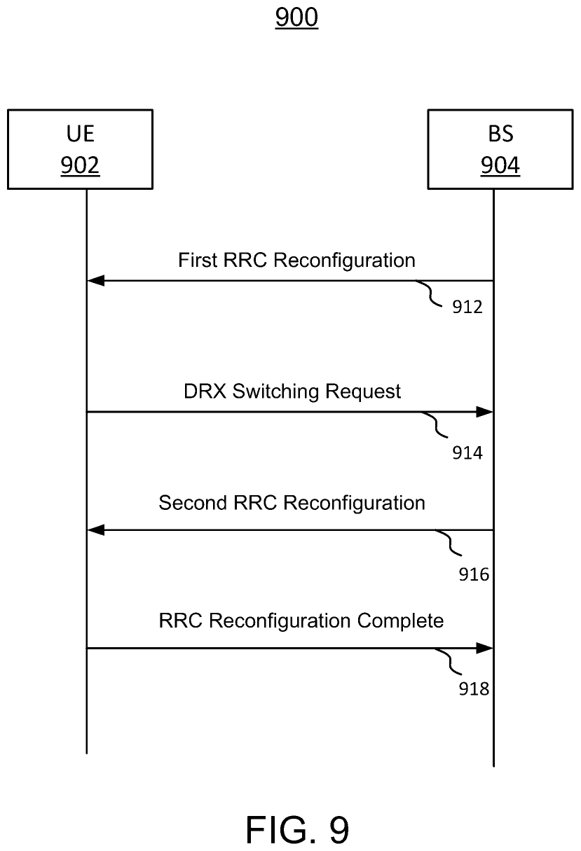

FIG. 9 is a diagram 900 illustrating switching between different DRX active configurations, according to an example implementation of the present disclosure. In action 912, UE 902 receives the first RRC reconfiguration message from BS 904. The first RRC reconfiguration message in action 912 may correspond to the first RRC reconfiguration message in action 302 in FIG. 3. In the example illustrated in FIG. 9, the first RRC reconfiguration message may include a first DRX configuration for a first serving cell and a second DRX configuration for the first serving cell. Two DRX configurations for the same serving cell are configured to UE 902. The first DRX active time is configured by the first DRX configuration, and the second DRX active time is configured by the second DRX configuration. The first DRX configuration is different from the second DRX configuration. For example, the first DRX cycle configured by the first DRX configuration may be different from a second DRX cycle configured by the second DRX configuration. Referring to action 304 in FIG. 3, the UE may adjust the first DRX active time to the second DRX active time according to the received first indication.

In action 914, UE 902 transmits a DRX switching request message to BS 904. For example, UE 902 may be an XR-specific UE or about to initiate a procedure for XR, and UE 902 may have its preferred DRX cycle values for its interested XR services. If the active DRX cycle value (e.g., configured by the first DRX configuration) does not match the preferred DRX cycle value, UE 902 may transmit the DRX switching request message to BS 904 to inform BS 904 that the DRX operation may need to be updated.

BS 904 may accept the DRX switching request. In action 916, BS 904 transmits a second RRC reconfiguration message to UE 902 in response to the DRX switching request message. Referring to action 304 in FIG. 3, the first indication may be received via the second RRC reconfiguration message. The second RRC reconfiguration message enables UE 902 to switch from the first DRX configuration to the second DRX configuration, thus enabling UE 902 to adjust from the first DRX active time to the second DRX active time.

In action 918, UE 902 may transmit an RRC reconfiguration complete message to BS 904 to confirm the reception of the reconfigured DRX cycle. Action 918 may be an optional step performed by UE 902. After switching to the second DRX configuration, UE 902 may perform the PDCCH monitoring during the second DRX active time.

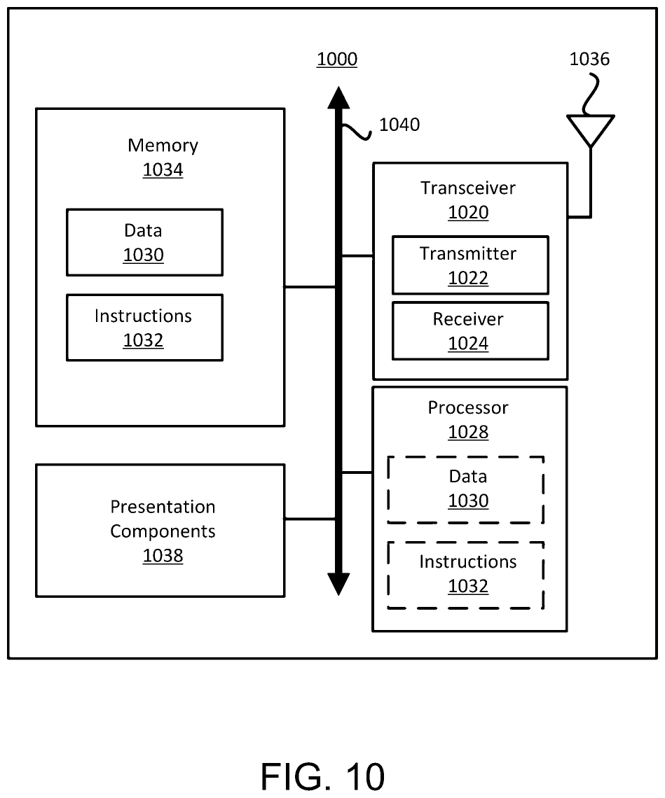

FIG. 10 is a block diagram illustrating a node 1000 for wireless communication, according to an example implementation of the present disclosure. As illustrated in FIG. 10, a node 1000 may include a transceiver 1020, a processor 1028, a memory 1034, one or more presentation components 1038, and at least one antenna 1036. The node 1000 may also include a radio frequency (RF) spectrum band module, a BS communications module, a network communications module, and a system communications management module, Input/Output (I/O) ports, I/O components, and a power supply (not illustrated in FIG. 10).

Each of the components may directly or indirectly communicate with each other over one or more buses 1040. The node 1000 may be a UE or a BS that performs various functions disclosed with reference to FIGS. 1 through 9.

The transceiver 1020 has a transmitter 1022 (e.g., transmitting/transmission circuitry) and a receiver 1024 (e.g., receiving/reception circuitry) and may be configured to transmit and/or receive time and/or frequency resource partitioning information. The transceiver 1020 may be configured to transmit in different types of subframes and slots including, but not limited to, usable, non-usable, and flexibly usable subframes and slot formats. The transceiver 1020 may be configured to receive data and control channels.

The node 1000 may include a variety of computer-readable media. Computer-readable media may be any available media that may be accessed by the node 1000 and include volatile (and/or non-volatile) media and removable (and/or non-removable) media.

The computer-readable media may include computer-storage media and communication media. Computer-storage media may include both volatile (and/or non-volatile media), and removable (and/or non-removable) media implemented in any method or technology for storage of information such as computer-readable instructions, data structures, program modules, or data.

Computer-storage media may include RAM, ROM, EPROM, EEPROM, flash memory (or other memory technology), CD-ROM, Digital Versatile Disks (DVD) (or other optical disk storage), magnetic cassettes, magnetic tape, magnetic disk storage (or other magnetic storage devices), etc. Computer-storage media may not include a propagated data signal. Communication media may typically embody computer-readable instructions, data structures, program modules, or other data in a modulated data signal, such as a carrier wave, or other transport mechanisms and include any information delivery media.

The term “modulated data signal” may mean a signal that has one or more of its characteristics set or changed in such a manner as to encode information in the signal. Communication media may include wired media, such as a wired network or direct-wired connection, and wireless media, such as acoustic, RF, infrared, and other wireless media. Combinations of any of the previously listed components should also be included within the scope of computer-readable media.

The memory 1034 may include computer-storage media in the form of volatile and/or non-volatile memory. The memory 1034 may be removable, non-removable, or a combination thereof. Example memory may include solid-state memory, hard drives, optical-disc drives, etc. As illustrated in FIG. 10, the memory 1034 may store a computer-readable and/or computer-executable instructions 1032 (e.g., software codes) that are configured to, when executed, cause the processor 1028 to perform various functions disclosed herein, for example, with reference to FIGS. 1 through 9. Alternatively, the instructions 1032 may not be directly executable by the processor 1028 but may be configured to cause the node 1000 (e.g., when compiled and executed) to perform various functions disclosed herein.

The processor 1028 (e.g., having processing circuitry) may include an intelligent hardware device, e.g., a Central Processing Unit (CPU), a microcontroller, an ASIC, etc. The processor 1028 may include memory. The processor 1028 may process the data 1030 and the instructions 1032 received from the memory 1034, and information transmitted and received via the transceiver 1020, the baseband communications module, and/or the network communications module. The processor 1028 may also process information to send to the transceiver 1020 for transmission via the antenna 1036 to the network communications module for transmission to a CN.

One or more presentation components 1038 may present data indications to a person or another device. Examples of presentation components 1038 may include a display device, a speaker, a printing component, a vibrating component, etc.

In view of the present disclosure, it is obvious that various techniques may be used for implementing the disclosed concepts without departing from the scope of those concepts. Moreover, while the concepts have been disclosed with specific reference to certain implementations, a person of ordinary skill in the art may recognize that changes may be made in form and detail without departing from the scope of those concepts. As such, the disclosed implementations are to be considered in all respects as illustrative and not restrictive. It should also be understood that the present disclosure is not limited to the particular implementations disclosed and many rearrangements, modifications, and substitutions are possible without departing from the scope of the present disclosure.

1-15. (canceled)

16. A method performed by a user equipment (UE) for a Discontinuous Reception (DRX) operation, the method comprising:
receiving, from a base station (BS), a Radio Resource Control (RRC) reconfiguration message including a DRX configuration for a serving cell;
determining a DRX active period based on the DRX configuration;
performing Physical Downlink Control Channel (PDCCH) monitoring during the DRX active period;
receiving a first indication from the BS; and
stopping the PDCCH monitoring during the DRX active period for a specific duration in response to receiving the first indication.

17. The method of claim 16, wherein the first indication is received via RRC signaling.

18. The method of claim 16, wherein the first indication is received via Downlink Control Information (DCI) addressed to a specific Radio Network Temporary Identifier (RNTI) different from a Cell-RNTI (C-RNTI).

19. The method of claim 16, wherein the specific duration is indicated by the first indication, configured via RRC signaling, or determined based on a specific timer.

20. The method of claim 16, wherein:
the stopping of the PDCCH monitoring starts at an offset after receiving the first indication, and
the offset is indicated by the first indication or configured via RRC signaling.

21. The method of claim 16, further comprising:
stopping a DRX timer configured by the DRX configuration in response to receiving the first indication.

22. The method of claim 21, wherein:
the DRX timer comprises at least one of a DRX inactivity timer, a DRX on-duration timer, a DRX retransmission timer, a DRX Hybrid Automatic Repeat Request (HARQ) Round Trip Time (RTT) timer, and a DRX short cycle timer.

23. The method of claim 16, further comprising:
receiving a second indication from the BS; and
restarting the PDCCH monitoring during the DRX active period in response to receiving the second indication.

24. The method of claim 16, wherein the first indication and the stopping of the PDCCH monitoring are specific to the serving cell.

25. A user equipment (UE) for a Discontinuous Reception (DRX) operation, the UE comprising:
at least one processor; and
at least one non-transitory computer-readable medium coupled to the at least one processor and storing one or more computer-executable instructions that, when executed by the at least one processor, cause the UE to:
receive, from a base station (BS), a Radio Resource Control (RRC) reconfiguration message including a DRX configuration for a serving cell;
determine a DRX active period based on the DRX configuration;
perform Physical Downlink Control Channel (PDCCH) monitoring during the DRX active period;
receive a first indication from the BS; and
stop the PDCCH monitoring during the DRX active period for a specific duration in response to receiving the first indication.

26. The UE of claim 25, wherein the first indication is received via RRC signaling.

27. The UE of claim 25, wherein the first indication is received via Downlink Control Information (DCI) addressed to a specific Radio Network Temporary Identifier (RNTI) different from a Cell-RNTI (C-RNTI).

28. The UE of claim 25, wherein the specific duration is indicated by the first indication, configured via RRC signaling, or determined based on a specific timer.

29. The UE of claim 25, wherein:
the stopping of the PDCCH monitoring starts at an offset after receiving the first indication, and
the offset is indicated by the first indication or configured via RRC signaling.

30. The UE of claim 25, wherein the one or more computer-executable instructions, when executed by the at least one processor, further cause the UE to:
stop a DRX timer configured by the DRX configuration in response to receiving the first indication.

31. The UE of claim 30, wherein:
the DRX timer comprises at least one of a DRX inactivity timer, a DRX on-duration timer, a DRX retransmission timer, a DRX Hybrid Automatic Repeat Request (HARQ) Round Trip Time (RTT) timer, and a DRX short cycle timer.

32. The UE of claim 25, wherein the one or more computer-executable instructions, when executed by the at least one processor, further cause the UE to:
receive a second indication from the BS; and
restart the PDCCH monitoring during the DRX active period in response to receiving the second indication.

33. The UE of claim 25, wherein the first indication and the stopping of the PDCCH monitoring are specific to the serving cell.

34. A base station (BS) for configuring a Discontinuous Reception (DRX) operation, the BS comprising:
at least one processor; and
at least one non-transitory computer-readable medium coupled to the at least one processor and storing one or more computer-executable instructions that, when executed by the at least one processor, cause the BS to:
transmit, to a user equipment (UE), a Radio Resource Control (RRC) reconfiguration message including a DRX configuration for a serving cell; and
transmit a first indication to the UE, wherein the UE:
determines a DRX active period based on the DRX configuration,
performs Physical Downlink Control Channel (PDCCH) monitoring during the DRX active period, and
stops the PDCCH monitoring during the DRX active period for a specific duration in response to receiving the first indication.

35. The BS of claim 34, wherein the one or more computer-executable instructions, when executed by the at least one processor, further cause the BS to:
transmit a second indication to the UE, wherein the UE restarts the PDCCH monitoring during the DRX active period in response to receiving the second indication.
